(19) United States
(12) Patent Application Publication
(10) Pub. No.: US 2018/0073245 A1
(43) Pub. Date: Mar. 15, 2018

(54) SEE-THROUGH PLASTIC CHAMBER INSULATORS

(71) Applicant: NanoSD Inc., San Diego, CA (US)

(72) Inventors: Youngjin Kim, San Diego, CA (US); Sungho Jin, San Diego, CA (US); Gunwoo Kim, San Diego, CA (US); Chulmin Choi, San Diego, CA (US)

(21) Appl. No.: 15/812,514

(22) Filed: Nov. 14, 2017

Related U.S. Application Data
(63) Continuation of application No. PCT/US2017/050131, filed on Sep. 5, 2017.
(60) Provisional application No. 62/383,564, filed on Sep. 5, 2016.
(60) Provisional application No. 62/413,522, filed on Oct. 27, 2016.
(60) Provisional application No. 62/470,274, filed on Mar. 12, 2017.
(60) Provisional application No. 62/535,866, filed on Jul. 22, 2017.

(51) Int. Cl. E04B 1/80; B29C 45/00; B29C 45/14; C08K 7/14; E04B 1/76

(52) U.S. Cl. CPC E04B 1/806; B29C 45/0001; E04B 2001/747; C08K 7/14; E04B 1/7612; B29C 45/14655

(57) ABSTRACT

A plastic chamber insulator is provided. The plastic chamber insulator includes at least two horizontally parallel plastic sheets, wherein edges of the at least two plastic sheets are sealed to form a chamber. The interior of the chamber is filled, for example, with CO₂ gas or air. The resultant product can be used for numerous insulation purposes.

### CROSS-REFERENCE TO RELATED APPLICATIONS

This application in a continuation of PCT Application No. PCT/US17/50131, filed on Sep. 5, 2017, which claims the priority benefit of U.S. Provisional Patent Application No. 62/383,564, filed on Sep. 5, 2016; U.S. Provisional Patent Application No. 62/413,522, filed on Oct. 27, 2016; U.S. Provisional Patent Application No. 62/470,274, filed on Mar. 12, 2017; and U.S. Provisional Patent Application No. 62/535,866, filed on Jul. 22, 2017.

### FIELD

The present invention relates generally to thermally insulating nanostructures and more specifically, for their use on building envelopes, as well as other applications.

### BACKGROUND

Thermal insulation materials are important for many engineering applications such as buildings, homes, automobiles, refrigerators, transportation vehicles, electronic devices, and apparel to keep a person warm. Buildings in the United States consume a significant amount of energy to regulate the indoor temperature using heating, ventilation and air conditioning (HVAC) systems. See for e.g.: L. Pérez-Lombard et al., Energ. Buildings, (2008); D. H. Li et al., Build. Environ., (2014); L. Malys et al., Build. Environ., (2014); Sawyer, K. (editor), “Windows and Building Envelope Research and Development: Roadmap for Emerging Technologies”. Building Technologies Office, EERE, U.S. Department of Energy (2014).

Heat loss through glass windows in cold weather across the U.S., especially the single-pane windows, amounts to a significant portion of primary energy consumption. Current technology for insulating windows include use of a double-pane type insulated glass unit (IGU), with a low-emissivity (low-e) coating on one of the surfaces. See for e.g.: T. Muneer et al., Architectural Press, (2000); 2011 Buildings Energy Databook, Tables 5.2.5 and 5.2.7. U.S. Department of Energy, Office of Energy Efficiency and Renewable Energy. Low-e window films can be applied to the interior surface of a window pane using adhesive means, so as to modify the optical properties of existing windows in buildings, homes and automobiles thereby minimizing the emission loss of IR radiation. However, interior surface condensation resistance is sacrificed by the low-e layer. See for e.g.: Wright, J. L., “The use of surface indoor low-e coatings: The implications regarding condensation resistance”, presented at the ARPA-E Workshop on Single-pane Window Efficiency (November, 2014). Such condensation can negatively affect the emissivity as well since water and ice are highly emissive.

Further, a hard-coat type low-e layer adds substantially to the cost of the single-pane insulating layer. While a commercially available low-e layer can simply be attached onto the surface of any new window structures, it is highly desirable if the low-e layer can also be added on to the insulating coating by inexpensive and easily scalable methods in a retrofit manner.

Potential energy savings by retrofitting single-pane glass windows with highly insulating layers could potentially save as much as $12 billion/year for US energy consumers.

### SUMMARY

Aspects of the present disclosure provide for energy saving materials having superior thermal insulating characteristics.

In one aspect of the present disclosure, an innovative arrangement of dual pane plastic panels (or chambers) that can be highly thermally insulating yet light enough and flexible enough to allow retrofitting to existing single pane glass windows is disclosed. According to the present disclosure, such plastic dual pane insulator panels, either a single chamber structured or subdivided into walled sections can be made into a standard window sizes and can simply be adhesive attached, Velcro®-attached or frame attached onto the glass window interior surface. These chambers can contain either vacuum, air or a heavy gas such as CO₂ for reduced thermal conductivity.

In another aspect of the present disclosure, a mechanically unique adjustment capability is provided in order to accommodate the temperature gradient and associated chamber deformation like bulging or curving, and strains induced by thermal expansion mismatch between the front panel plastic sheet vs the back sheet plastic sheet. To meet the need to create a highly insulating and transparent material that can be added as retrofits onto existing single-pane glass windows, the choice of plastic sheet material is one of the important factors. Highly porous silica aerogel exhibits a low K value of 0.02 W/mK, but has rather fragile mechanical properties and unsatisfactory optical transparency including bluish haze. Polymers such as Polyethylene terephthalate (PET, K˜0.15-0.25 W/mK), PMMA plexiglass acrylic (K˜0.18 W/mK), PS (polystyrene, K˜0.14-0.17 W/mK), Polyamide (PA, K˜0.24 W/mK), or polyimide (PI, K˜0.12 W/mK) type materials can be made optically transparent, and they generally exhibit ˜8 times lower K than silica, and are much lighter in weight.

In another aspect of present disclosure, a flexible plastic chamber which incorporates mechanisms to accommodate the thermally induced, mechanical distortions and stresses for long-term durability is provided.

In another aspect of the present disclosure, a multilayered plastic chamber is provided to increase thermal insulation, with optional subdivision into various lateral sections for enhanced sealing of trapped gas.

In another aspect of the present disclosure, a subdivided, preferably periodic, nanoscale air compartment configuration in a plastic-array or plastic-framed structure is provided so as to impart much lowered thermal conductivities of e.g., ˜0.05 W/mK or below, with a corresponding low U-factor and in the meantime possess a much more robust mechanical properties compared to silica aerogel. For efficient thermal insulation for glass windows, the desirable winter U-factor should be less than 0.50 BTU/sf/hr/° F., corresponding to the thermal conductivity requirement of K<0.05 W/mK. In order to achieve such a low thermal conductivity, it is desirable to avoid a relatively high thermal conductivity material such as silica (K˜1.4 W/mK), unless extremely small volume fraction is utilized with corresponding fragile mechanical characteristics. Therefore, it is desirable to start with a lower K material such as a polymer. Considering that the K_{(polymer)} is 0.18 W/mK and K₍ₐᵢᵣ₎ is 0.025 W/mK, obtaining a desirably low K value of e.g., <0.05 W/mK requires a reasonable combination of polymer material volume and air (or gas) trapped within.

In another aspect of the present disclosure, flexible plastic chamber configurations, single layer or multilayer, as well as periodically compartmented, nanoscale subdivided plastic configurations are provided to produce highly efficient thermal barrier layers for window glass application and other uses. The subdivision, if made into a nanoscale, deep subwavelength dimensions, which can effectively induce the desired optical transparency.

Further, in another aspect of the present disclosure, a plastic chamber insulator is provided. The insulator includes at least two horizontally parallel microscale or nanoscale plastic sheets, wherein edges of the plastic sheets are sealed to form a chamber. In embodiments, the chamber comprises a diameter of less than 100 nm. In embodiments, the chamber comprises a diameter of above about 2 μm. In embodiments, the chamber is filled with vacuum, air, or a heavy gas. In embodiments, the heavy gas comprises CO₂ or a mixture containing CO₂. In embodiments, the plastic chamber insulator is optically transparent or optically non-transparent. In embodiments, the plastic chamber insulator exhibits an optical scattering haze of less than about 10%, or less than about 5%, or less than about 2%. In embodiments, the plastic chamber insulator has an optical transmission in the visible range of at least about 80%, or at least about 85%, or at least about 90%. In embodiments, the plastic chamber insulator of claim 1, further comprising a reinforcing pillar attached to at least one of the plastic sheets. In embodiments, the plastic chamber insulator is comprised of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), or polyvinylidene fluoride (PVDF), polycaprolactam (nylon), polycarbonate (PC), polyoxymethylene (POM), polyether ether ketone (PEEK), or any combination thereof. In embodiments, the plastic chamber insulator has a thermal conductivity value of less than about 0.10 W/mK, or less than about 0.05 W/mK, or less than about 0.03 W/mK. In embodiments, at least one portion of the plastic chamber insulator contains an adhesive layer.

In another aspect of the present disclosure, a method of producing an insulator cell structure is provided. The method includes inserting a vertical multiple-blade shape die into uncured polymer or a spin-on-glass matrix to form vertical high-aspect-ration grooves; curing the polymer while maintaining the die in a fixed position; and removing the die from the cured polymer to form a chamber. In embodiments, the die is coated with an anti-stiction coating or a lubricant coating. In embodiments, the die is coated with a self-assembled monolayer (SAM). In embodiments, the die is coated with octadecyltrichlorosilane (CH₃(Ch₂)₁₇SiCl₃, called OTS), or 1H, 1H, 2H, 2H-perfluorodecyltrichlorosilane (CF₃(CF₂)₇(CH₂)₂SiCl₃, called FDTS), or teflon, graphene or MoS₂ coating. In certain embodiments, the curing is carried out by thermal curing, or UV irradiation. In embodiments, the polymer is cured initially at a low temperature, and then at a second higher temperature. In embodiments, the method further includes introducing a capping layer plastic sheet to the top surface of the insulator cell structure. The embodiments, the method further includes filling the chamber with vacuum, air, or a heavy gas. In embodiments, the method further comprises repeating the described steps to prepare a vertical stack of insulator cell structure layers. In embodiments, the method further includes introducing a lateral curvature of lateral wrinkling of the vertical stack; introducing vertical wrinkling of the vertical stack; or introducing sideway horizontal bridging to the vertical stack, or a combination thereof. In another aspect of the present disclosure, a method of insulating a window is provided. The method includes attaching a layer of the plastic chamber insulator to the window. In embodiments, the plastic chamber insulator is attached to the window by an adhesive.

In another aspect of the present disclosure, a plastic chamber insulator is provided. The insulator includes at least two horizontally parallel plastic sheets, wherein edges of the plastic sheets are sealed to form a chamber having an interior, and wherein the interior of the chamber is filled with CO₂ gas, air, or vacuum. In embodiments, the plastic sheets have a thickness of less than 200 μm, and the chamber has a thickness of less than 5 mm. In embodiments, the chamber is compartmented into a smaller array of chambers. In embodiments, the plastic chamber insulator is optically transparent or optically non-transparent. In embodiments, wherein the plastic chamber insulator exhibit an optical scattering haze of less than about 10%, or less than about 5%, or less than about 2%. In embodiments, the plastic chamber insulator has an optical transmission in the visible range of at least about 80%, or at least about 85%, or at least about 90%. In embodiments, the chamber further comprises an array of internal spacer pillars attached to at least one of the plastic sheets to support the plastic sheets of the chamber. In embodiments, each of the internal spacer pillars has a cross-sectional diameter of less than 5 mm. In further embodiments, the plastic chamber insulator is comprised of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), or polyvinylidene fluoride (PVDF), polycaprolactam (nylon), polycarbonate (PC), polyoxymethylene (POM), polyether ether ketone (PEEK), or any combination thereof. In embodiments, the plastic chamber insulator has a thermal conductivity value of less than about 0.10 W/mK, or less than about 0.05 W/mK, or less than about 0.03 W/mK. In embodiments, at least one portion of the plastic chamber insulator contains an adhesive layer. In embodiments, the plastic chamber insulator is mechanically flexible allowing for a bending of the plastic chamber insulator having a radius of curvature of less than 2 meters. In embodiments, the edges of the plastic chamber insulator are raised.

In another aspect of the present disclosure, a method of producing a plastic chamber insulator is provided. The method includes positioning two or more sheets of thin and flexible plastic in a parallel configuration, wherein each of the sheets has a thickness of less than 500 μm, and sealing edges of the plastic sheets to form a chamber, wherein the chamber has an internal volume; and filling the internal volume of the chamber with CO₂ gas, air or vacuum. In embodiments, the plastic is comprised of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), or polyvinylidene fluoride (PVDF), polycaprolactam (nylon), polycarbonate (PC), polyoxymethylene (POM), polyether ether ketone (PEEK), or any combination thereof. In another aspect of the present disclosure, a method of insulating a window is provided, the method involves providing a plastic chamber insulator as described herein and securing the plastic chamber insulator to a face of the window. Optionally, the attachment is carried out through use of an adhesive.

### BRIEF DESCRIPTION OF THE DRAWINGS

The nature, advantages and various additional features of the invention will appear more fully upon consideration of the illustrative embodiments now to be described in detail with the accompanying drawings. In the drawings:

FIGS. 1A-1B depict transparent (or non-transparent) plastic insulator layer comprising vertically elongated micro or macro cell array.

FIGS. 2A-2C depict an example method of producing a three-dimensionally stacked multilayer book page structure for increased insulation and mechanical strengthening.

FIG. 3A depicts an example plastic insulator structure comprising vertically, parallel-elongated cell array, specifically an example PMMA (acrylic plexiglass) vertical sheet array.

FIG. 3B depicts an example plastic insulator structure comprising vertically, parallel-elongated cell array, specifically an example intentionally wrinkled PMMA sheet array for strengthening.

FIG. 3C depicts an example plastic insulator structure comprising vertically, parallel-elongated cell array, specifically an example schematic of parallel and wrinkling curved PMMA wall array for mechanical strengthening.

FIGS. 4A-4B depict an example method of using vertical compression deformation wrinkling and fixing to introduce lateral bridging for mechanical strengthening.

FIGS. 5A-5B depict an example method of producing a lateral bridge structure for mechanical strengthening using periodic injections of curable polymer liquid during pull out of the die.

FIGS. 6A-6D depict example vacuum-filled, air-filled or CO₂-filled nano chamber or micro chamber or milli chamber array for enhanced mechanical strength and thermal insulation performance.

FIGS. 7A-7B depict a schematic illustration of an example compartmented plastic chamber array filled with air, CO₂, or vacuum as a retrofittable thermal insulator for windows.

FIG. 8A depicts a cross-sectional view of an example compartmented plastic chamber insulator for window and other applications with straight vertical walls of a plastic.

FIG. 8B depicts a cross-sectional view of an example compartmented plastic chamber insulator for window and other applications with corner-rounded vertical walls of a plastic.

FIG. 9 depicts an example of how pre-made plastic walls can be inserted between the top and bottom plastic panels and assembled into a mini chamber array structure by thermal, chemical or adhesive bonding.

FIGS. 10A-10B depict an example method of assembly of mini chamber array (vacuum filled, air filled, or CO₂ type gas filled) using a pre-made and one side pre-attached plastic wall array of plastic. In FIG. 10A the one side pre-attached structure is lowered onto the bottom panel for attachment, and in FIG. 10B, bonding of the vertical wall ends and the bottom panel using laser or IR heat wave, either blanket heating or localized heating aimed at the contact points.

FIGS. 11A through 11C depict example ways of utilizing the highly thermally insulating, plastic mini chamber array laminate.

FIG. 12 depicts an embodiment of a dual-pane plastic insulator panel with the chamber filled with air, with a heavy gas like CO₂, or pumped to a vacuum state (e.g., less than 10⁻¹ torr level).

FIG. 13 depicts a spacer array reinforced embodiment of a plastic chamber construction by combining the upper and lower plastic sheet with the periodic plastic spacer (preferably the same material as the upper and lower sheet plastic.

FIG. 14 depicts cross-sectional views of example plastic chamber insulators.

FIG. 15A depicts an example method of seamless bonding of single layered or multi-layered chamber by heat bonding (via convection, radiation, torch flame, hot air blow, laser beam, IR, etc.), chemical bonding or adhesive bonding.

FIG. 15B depicts an example of an insulator chamber held against the sky to demonstrate the insulator chamber's see-through characteristic.

FIG. 16 depicts an example of adhesive-backed plastic layer attachment onto a glass surface.

FIG. 17 depicts an example of plastic chamber insulator attachment on raised edges to prevent trapped air bubble, and to add extra insulating air layer next to the glass.

FIG. 18 depicts the expected contraction or expansion of gas-filled or vacuum-filled plastic dual pane insulator chamber, which will cause a distortion of the plastic insulator chamber shape, and pose a problem of how to maintain a reasonable flat geometry during temperature change.

FIG. 19A depicts an example use of flexible attachments like Velcro type, zipper type, press-on buttons, or other mechanisms to mitigate the problem of thermal expansion and contraction.

FIG. 19B depicts an example use of one or both surfaces of the plastic chamber being curvature or corrugated to accommodate thermal expansion/contraction and associate CO₂ or air volume change within the plastic chamber insulator.

FIG. 20 depicts an example use of flexible connectors (such as corrugated plastic or elastic metal sheet) to accommodate thermal expansion/contraction strains and buckling of plastic chamber insulator on temperature change.

FIG. 21 depicts an example volume compensator that can shrink or expand to accommodate the temperature change induced gas expansion or contraction within the dual pane chamber.

FIG. 22 depicts an example forceful volume compensator structure which can expand or contract by temperature change to stabilize the gas pressure in the plastic chamber insulator structure.

FIG. 23 depicts an alternative method of compensating the volume shrinkage on temperature change using a repeatably deformable portion of the plastic chamber insulator wall structure. The deformable portion can expand or shrink to absorb the air or CO₂ volume expansion or contraction on temperature change or temperature-gradient-change, so as to keep the shape/geometry of the flat face portion of the plastic chamber insulator basically unchanged.

FIG. 24 depicts an optional use of a fill/refill port to adjust the gas pressure or vacuum level. Also a leak detector (e.g., thin sticker type sensor) can optionally be attached on the inside wall. When the heavy gas inside the structure leaks and the outside air partially replaces the heavy gas, the sensor will display a warning sign so that the filling gas can be replaced or replenished.

FIG. 25A depicts an example of an attachable half-shell plastic chamber structure which is ready to be attached onto existing window glass surface using adhesive bonding.

FIG. 25B depicts an example of an adhesive attachment followed by CO₂ filling and sealing.

FIG. 26 depicts an example formation of plastic chamber insulator by bonding of at least two parts of plastic components.

FIGS. 27A-27E depict an example method of injection molding of bent plastic components and combining/bonding mating parts into the desired final chamber insulator shape. The interior can be filled with lower thermal conductivity CO₂ gas.

FIGS. 28A-28D depict an example method of one-shot injection molding of a plastic perform piece into the desired final plastic chamber insulator shape. This process is fast and inexpensive for large-scale manufacturing.

It is to be understood that the above-described drawings are for purposes of illustrating the concepts of the invention and are not to scale.

### DETAILED DESCRIPTION

### Definitions and Interpretation

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

The articles “a” and “an” are used herein to refer to one or to more than one (i.e., to at least one) of the grammatical object of the article. By way of example, “an element” means one element or more than one element.

The term “about” means a quantity, level, value, number, frequency, percentage, dimension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length.

Throughout this disclosure, unless the context requires otherwise, the words “comprise,” “comprises,” and “comprising” will be understood to imply the inclusion of a stated step or element or group of steps or elements but not the exclusion of any other step or element or group of steps or elements.

As may be used herein, the term “consisting of” means including, and limited to, whatever follows the phrase “consisting of.” Thus, the phrase “consisting of” indicates that the listed elements are required or mandatory, and that no other elements may be present. The term “consisting essentially of” means including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

### DESCRIPTION OF EMBODIMENTS

As is well known, a substantial portion of all primary energy is consumed for heating and cooling of buildings and homes to enhance human comfort. Buildings and homes in which we perform work and live in, represent one of the largest energy-consuming sectors in the modern economy. Therefore, the energy/electricity uses are also responsible for significant amount of global carbon emissions. With an anticipated increase in population and improved living standards, energy use in buildings is also anticipated to increase much in coming decades. The building envelope defined as the boundary between the air conditioned or heated interior of the building and the outdoor atmosphere includes windows, walls, floors, doors and roofs, can be improved substantially by efficient insulation, especially for the glass windows, as the thermal insulation performance of the glass windows is critical in determining how much energy or electricity is required for heating and cooling.

It is therefore essential to develop more efficient, insulator materials for windows, which also have to be optically transparent. The present disclosure describes various embodiments of new materials and structures related to thermally insulating structures for use on building envelopes, transport vehicles, electronic devices, and other applications. Various inventions and embodiments are described in this patent application, as listed and described below. The broad category of the present disclosure provides for optically transparent or non-transparent, thermally insulating structures (for building and home windows, walls or other envelopes, as well as for general insulating applications), can be grouped into two types of embodiments of (i) macro/micro/nano-subdivided polymer structures with unique mechanical and thermal design arrangements, and (ii) flexible plastic chamber structures with innovative thermal distortion accommodation structures.

There are many types of plastic materials that can be fabricated into the described structures for enhanced thermal insulation. According to the present disclosure, the plastic materials suitable for disclosed embodiments can be selected from the list of materials including (but not restricted to) polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymers thereof, any combinations thereof, and any combination of these polymers with reinforcing inclusions such as particles or fibers of non-polymer materials.

Several variations of exemplary embodiment structures for the invention are described as follows.

### Embodiment Structure Type A: Parallel Vertical Layer Assembly Structure

In this embodiment, such optically transparent, highly insulating coating layer is described. Non-transparent insulators are also useful for some applications such as building/home walls.

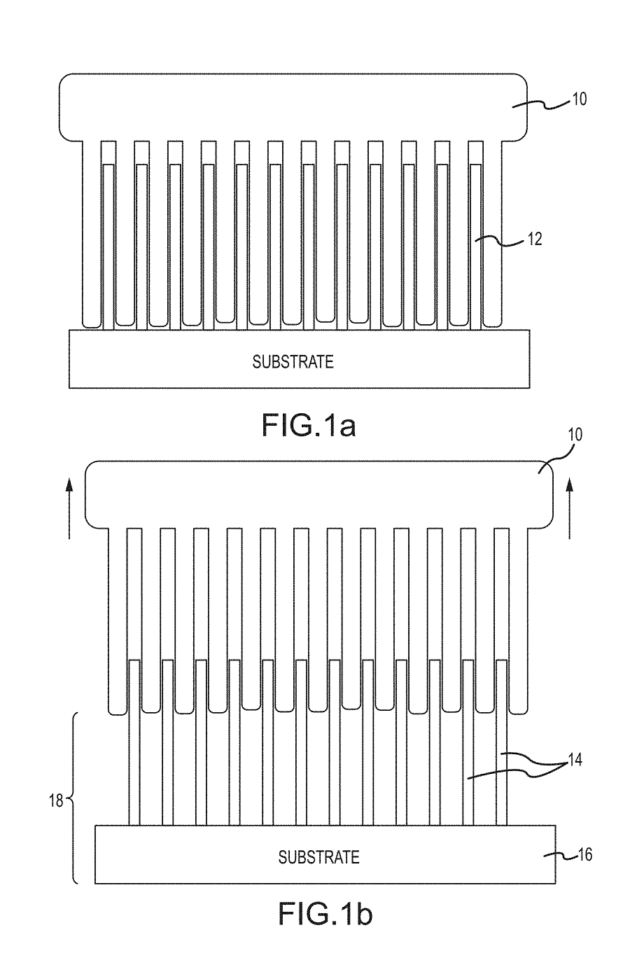

Shown in FIG. 1 is a transparent insulator layer comprising a vertically elongated micro cell array according to the present disclosure. The fabrication methods for such a structure is illustrated in the figure. A vertical cell structure is fabricated by inserting a vertical multiple-blade-shape die (10) made of high strength metal, ceramic, polymer or composite material into uncured polymer or spin-on-glass matrix (12) as shown in FIG. 1A. For transparent thermal insulation purpose, preferred polymer material is selected from a list of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymers thereof, any combinations thereof, and any combination of these polymers with reinforcing inclusions such as particles or fibers of non-polymer materials.

The surface of the die is coated with anti-stiction coating (release agent) or lubricant coating such as self-assembled monolayer (SAM) coating such as octadecyltrichlorosilane (CH₃(Ch₂)₁₇SiCl₃, called OTS), or 1H, 1H, 2H, 2H-perfluorodecyltrichlorosilane (CF₃(CF₂)₇(CH₂)₂SiCl₃, called FDTS), or teflon, graphene or MoS₂ coating, which can be washed away or dissolved away if needed). The die (10) is pressed into uncured precursor polymer (or molten polymer) (12) or uncured spin-on-glass type polymer matrix (container not shown) to form vertical, high-aspect-ratio grooves, and the polymer is then cured by heat or UV or catalyst reaction.

The polymer or spin-on-glass polymer composite is then cured while keeping the pressed die (10) in position, e.g., by heating in an oven at 60-150° C. for thermal curing, by UV irradiation curing if the polymer is e.g., UV-curable PMMA, or by solidification if a molten plastic is utilized instead of uncured polymer precursor liquid. The multi-blade die (10) is then removed, as shown in FIG. 1B, by pulling upward to leave a vertical book-page-array polymer (14). The curing of polymer can cause lateral contraction, which can be utilized for easier removal of the die blades. Optionally the polymer can be cured in two steps, e.g., half-cured by heating to 60-80° C. and release the die first, and then the second curing by heating to a higher temperature is given for full cure. A capping layer plastic sheet is then added and attached as a top surface by using the tacky viscous plastic or by using adhesive material or by using chemically dissolved gooey state (e.g., Plexiglass PMMA made sticky by dissolving with ethylene dichloride).

The desired dimension of the nano-scale vertical wall array structure (18), according to the present disclosure, is the thickness of the wall in the range of 50 nm-50 μm, preferably in the range of 100 nm-5 μm, even more preferably in the range of 100 nm-2 μm. The desired spacing between adjacent vertical sheet wall is at least 2 times thicker than the sheet thickness, preferably at least 5 time, even more preferably at least 10 times.

For the purpose of a more optically transparent plastic wall array structure, the dimensions are selected to be micro-scale, instead of nanoscale, although the nanoscale structure will give more reduced thermal conductivity for insulation purpose. The desired dimension in the case of microscale vertical wall array has the thickness of the plastic microsheet in the range of 2-1,000 μm, preferably 10-500 μm, more preferably 50-200 μm. The desired spacing between adjacent vertical sheet wall in the microscale structure is at least 2 times thicker than the sheet thickness, preferably at least 5 time, even more preferably at least 10 times.

The desired range of the height of the vertical wall depends on the thickness of each vertical wall, and is typically in the range of 10-20,000 times the thickness of the vertical wall, preferably in the range of 100-5,000 times, more preferably in the range of 200-1,000 times.

With the low K (thermal conductivity) of polymer in combination with empty-space air (or gas or vacuum) having 80-99% volume fraction, as can be made by the multi-blade process shown in FIGS. 1A-1B, a highly insulating transparent layer is prepared. The volume of air trapped in such a structure is, e.g., ˜95%, if the resultant polymer book page width is 30 μm, with the spacing between adjacent pages is set to be 600 μm. This exemplary configuration provides a quite low, estimated thermal conductivity value of K=0.032 W/mK (based on volume ratio calculation, using K(PET)=0.18 W/mK and K(air)=0.024 W/mK).

Depending on the relative volume fraction of the plastic vs. air, the resultant thermal conductivity of the multi-blade processed, which is also termed a “Parallel Vertical Layer Assembly Structure” in FIG. 1 is desirably in the range of 0.02-0.1 W/mK, preferably in the range of 0.02-0.05 W/mK useful for building window insulation to save energy. Such a plastic insulator layer, e.g., 1-3 mm thick, can be prepared in a scaled-up manufacturing. The vertical direction aligned structure in FIG. 1 gives optical transparency in the vertical direction. As these 30 μm type plastic page thickness dimension is far above the visible spectrum, very little optical interference and haze effect are expected.

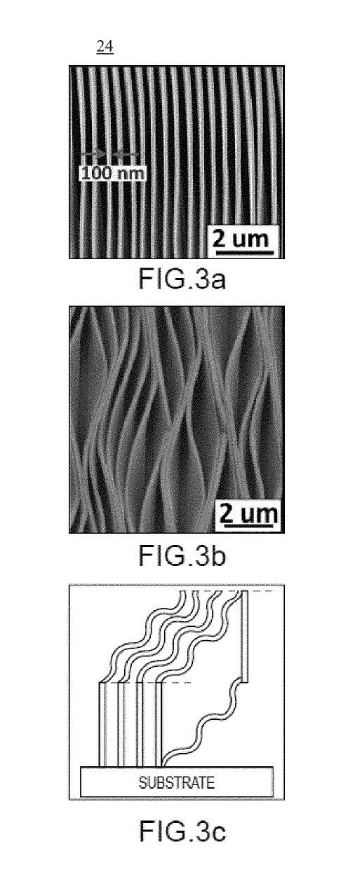

An example of a vertical plastic wall array structure made from PMMA (plexiglass) polymer material is shown in FIG. 3A. An example fabrication dimension can be 1 m by 1 m area. An example layer can have 30 μm thick polymer pages with 600 μm width spacing, and 0.1-0.5 mm height for each layer.

### Embodiment Structure Type B: 3-D Stacked Vertical Array Structure

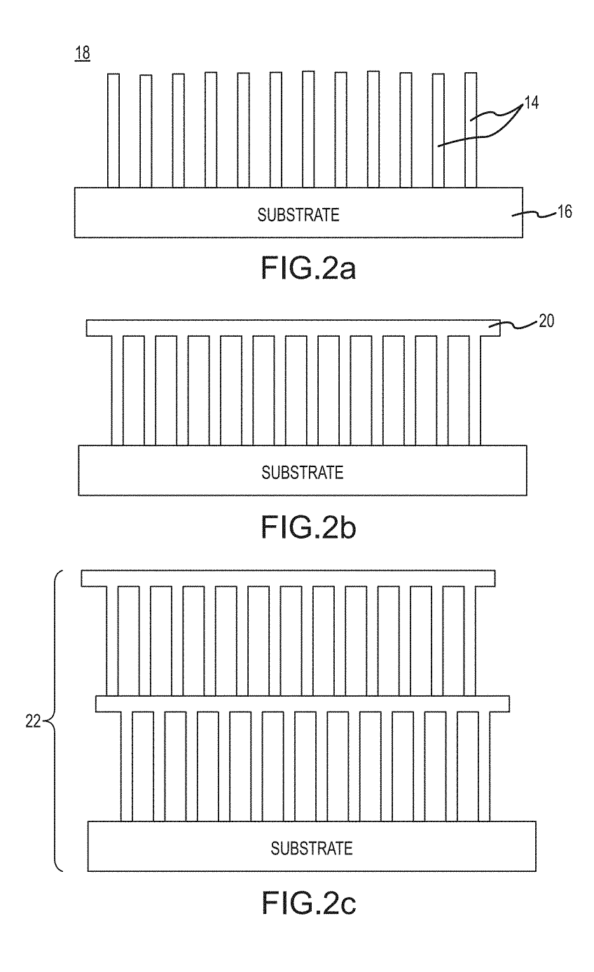

The plastic vertical wall array structure of FIG. 1 can be repeated and stacked into a three-dimensional, thicker layer as some thickness of insulating layer is desired for more efficient blocking of heat flow. Shown in FIGS. 2A-2C is an example of a method of producing a three-dimensionally stacked multi-layer configuration of book page layers. After the first book page layer (18) is made by the FIG. 1 method, as depicted in FIG. 2A, a thin horizontal layer of the polymer (20) is placed, and bonded using an optional uncured polymer sprinkled or spray coated in small amount as an adhesive/bonding material, as shown in FIG. 2B. Alternatively, a chemical bonding, e.g., using ethylene dichloride solvent on Plexiglas (PMMA) plastic sheets can be used to partially dissolve the surface to create gooey/tacky contacts for bonding of the vertical layers onto the horizontal top plastic sheet, as the evaporation of the solvent causes the bonding of plexiglass parts. An epoxy type adhesive can also be utilized for bonding.

A transfer and placement of such a flat horizontal polymer sheet, e.g., 30-250 μm thickness, can be made by using vacuum suction type sheet holder. The desired number of stacked layers in the multilayered vertical-wall structure (22), as depicted in FIG. 2C, depends on the height of each layer, and is in the range of 2-2,000, preferably in the range of 5-1,000, and more preferably in the range of 10-200. The process can be repeated to build between a 2-3 mm thick multilayer structure. This multilayer structure may contain 90-98% of trapped air pockets (or other suitable gases such as CO₂).

While the transparent insulator structure shown in FIG. 1 represents a good insulator configuration, the mechanical strength of this structure may not be strong as the very high aspect ratio sheets can easily buckle on compressive stress. The structure can be strengthened by utilizing a thicker plastic frame as a structural support.

It is also desirable if some intrinsic structural modifications can be made. According to the present disclosure, the following three approaches can be utilized for such strengthening of the parallel book-page structure: (i) intentional lateral curvature or lateral wrinkling of the vertical plastic book pages; (ii) by introducing vertical wrinkling of book pages for strengthening; and (iii) sideway horizontal bridging to reinforce the structure. These approaches are described in the following Embodiments described below (e.g., FIG. 3-FIG. 5).

### Embodiment Structure Type C: Intentionally Wrinkled Vertical Polymer Page Structure

Shown in FIG. 3 is an SEM micrograph of an example plastic insulator structure comprising parallel, vertically elongated cell array (24), schematically illustrated in FIG. 1. The book page structure of ˜100 nm wall thickness and ˜200 nm lateral spacing was prepared by using a multi-blade die (10) made of patterned silicon, which was utilized to imprint into uncured PMMA (acrylic plexiglass) for vertical page array fabrication. When an uncured PMMA material wall with increased solvent concentration (acetone) is utilized, the drying of solvent from the PMMA page structure (with the multi-blade removed in the semi-cured condition), a self-assembly type wrinkling of PMMA nanosheet array naturally occurs, with an example behavior shown in FIG. 3B. Such a sideways wrinkling, if properly designed and processed, can provide mechanical strengthening to the vertical wall structure. A schematic of the parallel and wrinkling curved PMMA wall array structure is schematically illustrated in FIG. 3C.

The degree of desired wrinkling is a radius of curvature in the range of 100 nm-100 μm, preferably in the range of 1 μm-10 μm.

### Embodiment Structure Type D: Compression-Wrinkled Microbubble Polymer Assembly Structure

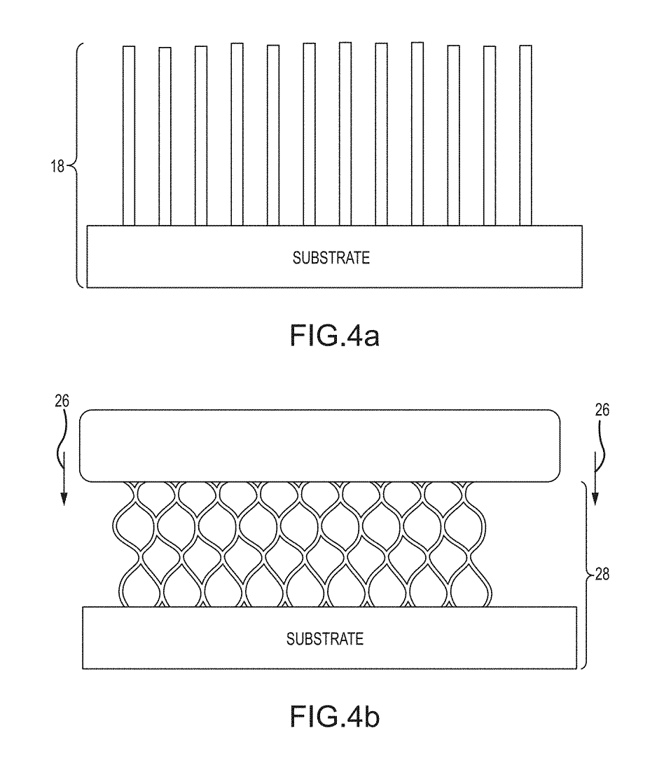

In FIG. 4, vertical book-page array of fully cured (or preferably half cured) polymer sheets (18) such as shown in FIG. 1 is prepared first, as shown in FIG. 4A. Then a compressive force (26) is applied to permanently deform the vertically parallel book page sheets to make them buckle and contact neighboring polymer sheets, so as to produce a laterally connected supporting structure (28) for mechanical strengthening. If the vertical sheets are only half-cured, or if some uncured polymer nano/micro particles are sprayed between adjacent sheets prior to compress deformation followed by heat-induced or UV-induced curing, the buckled sheets can more easily bond to neighboring sheets during compression. The compressive force may be maintained for some period during full curing of the previously half cured sheets being pressed/buckled, to allow more time for the lateral adhesion of the buckled sheets. Alternatively, fully cured but buckled structure can be subjected to higher temperature near the glass transition temperature (Tg) so that the lateral contact points of the plastic microsheets become bonded. These processes enable a relatively easy fabrication of optically transparent and highly insulating polymer structure (similar to a foam structure), especially if CO₂ type heavy gas is trapped. The 30 μm polymer page width and 600 μm spacing type length scale does not interfere with visible light wavelength and hence the haze problem will be minimized. This is an inexpensive and very scalable method to produce strengthened polymer structures with much air volume fraction trapped for desirable low thermal conductivity of ˜0.02-0.05 W/mK.

While the nanoscale vertical walled (18) or buckled wall (28) structures will give more reduced thermal conductivity for insulation purposes, for the purpose of more optically transparent structure, the dimensions are selected to be micro-scale, instead of nanoscale.

The desired dimension of this type of micro structure has the thickness of the plastic microsheet in the range of 2-1,000 μm, preferably 10-500 μm, more preferably 50-200 μm. The desired spacing between adjacent vertical sheet wall is at least 2 times thicker than the sheet thickness, preferably at least 5 time, even more preferably at least 10 times. The average of frequency of buckling is made to occur at least 10 times along the thickness of the overall structure, preferably at least 20 times, more preferably at least 50 times.

### Embodiment Structure Type E: 3-D Laterally Bridged Vertical Layer Assembly Structure

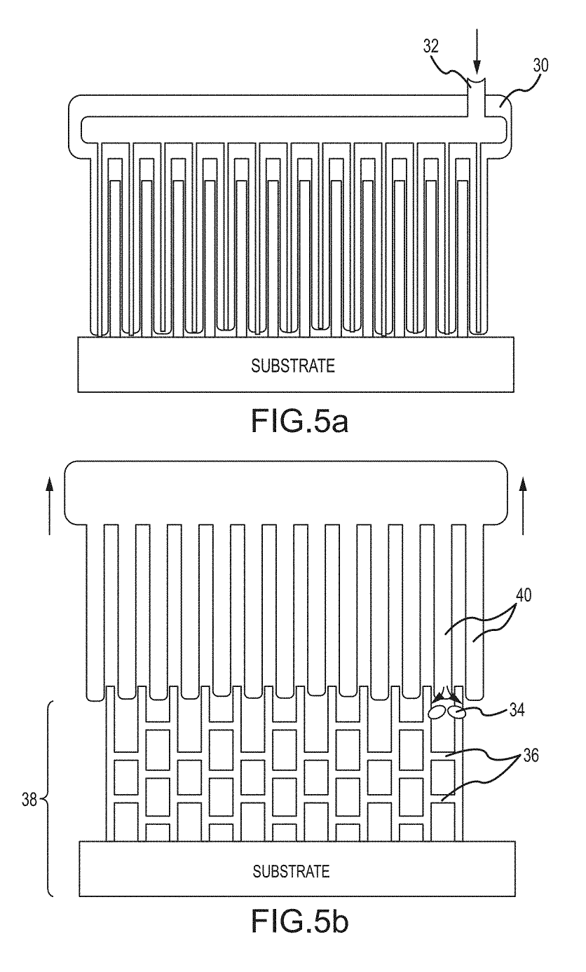

In FIGS. 5A-5B, an array injectable die (30) is used to supply laterally bridging polymer (32), as depicted in FIG. 5A, during the upward pull out of the die (30) to strengthen the polymer structure after the bridges are also cured, as depicted in FIG. 5B. Such a structure can be fabricated in an industrially viable way if each of the vertical die blades (or some selected number of blades) has an internal channel path (34) to release/dispense uncured liquid polymer material (32) (either the same polymer or other curable polymer) in a programmable manner (or periodically), so as to create lateral bridges (36) with appropriate vertical frequency as depicted in FIG. 5B. These liquid, semi-viscous polymer bridges (36) can be cured to provide sufficient strengthening.

The laterally bridged vertical-wall structure (38) can be made in nano-scale or micro-scale. While a nanoscale structure will give more reduced thermal conductivity for insulation purpose, for the purpose of more optically transparent structure, the dimensions are selected to be micro-scale, instead of nanoscale. The desired dimension of this type of micro-scale structure has the thickness of the plastic microsheet in the range of 2-1,000 μm, preferably 10-500 μm, more preferably 50-200 μm. The desired spacing between adjacent vertical sheet wall is at least 2 times thicker than the sheet thickness, preferably at least 5 time, even more preferably at least 10 times. at least 2, preferably at least 5, even more preferably at least 10. The average of frequency of buckling is made to occur at least 10 times along the thickness of the overall structure, preferably at least 20 times, more preferably at least 50 times. The width of each die blade (40) can be 600 μm while polymer book-page width can be 30 um. The 600 μm width is sufficient to prepare an internal hole-like path to programmably supply uncured polymer (32) every 100 μm height for lateral bridging. The bridging liquid release (32) can be uniform for all the bridges or can be alternately releasing for the neighboring bridges by more sophisticated design.

### Embodiment Structure Type F: Vacuum or Gas-filled Nano-Bubble or Micro-Bubble Array Structure

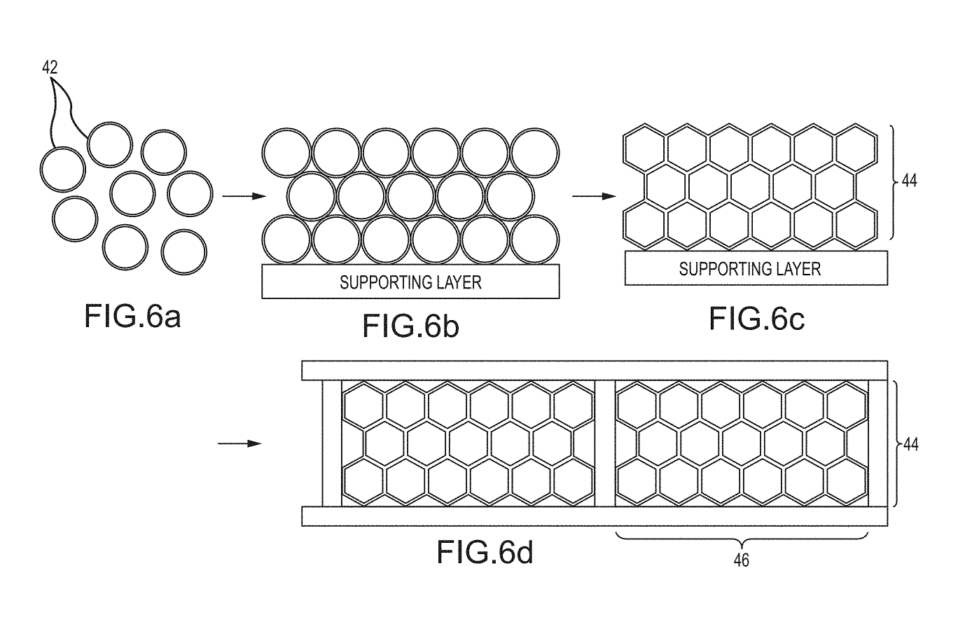

Yet another alternative structure to further strengthen the plastic chamber structure and obtain low thermal conductivity, combined with optical transparency, according to the present disclosure, is to use polymer nanospheres or microspheres, optionally putting vacuum or CO₂ gas inside the hollow sphere interior, as illustrated in FIGS. 6A-6D. In case an optically transparent (or almost transparent/translucent layer) is desired, the diameter of the hollow spheres (42) can be restricted, according to the present disclosure, to below 100 nm (preferably less than 60 nm) or above 2 μm (preferably greater than 5 μm) in order to avoid the visible spectrum regions and associated light scattering and haze issues.

The hollow spheres (42) can also be prepared to contain vacuum or lower-thermal-conductivity CO₂ gas (K=0.016 W/mK, about 36% lower than the thermal conductivity of air, K=0.025 W/mK) inside instead of air. Such a removal of air provides a much lower thermal conductivity. According to the present disclosure, this is accomplished by placing the nanobubble or microbubble assembly inside of polymer chamber such as made of PET (Polyethylene terephthalate) plastic which is capable of containing pressure gas such as CO₂ or some level of vacuum. The arrangement is then subjected to vacuum pumping and sealing of the plastic chamber as a part of the overall insulator structure. During or after the sealing, the chamber structure can be heated to near the glass transition temperature of the polymer nanobubble or microbubble materials (42), so as to sinter and form locally sealed structure array that also locally traps the vacuum or CO₂ gas inside the bubbles. Such a bubble sealing provides an extra safety in terms of long-term containment of trapped vacuum or trapped CO₂ gas in the overall insulator structure.

The thermal conductivity K of vacuum is very low (essentially zero), and even in an industrial case of vacuum-filled double pane glass window, can be less than 0.004 W/mK. The thermal-conductivity CO₂ gas (K=0.016 W/mK) is about 36% lower than that of air (K=0.025 W/mK), which enables a significant improvement in thermal insulation. These vacuum-filled or CO₂-filled spheres (42) can be stacked, as depicted in FIGS. 6B and 6C, e.g., in a hexagonal pattern, and sintered, preferably in a vacuum environment, which results in a network or honeycomb type or other related configurations. For stacked hollow polymer spheres, the sintering temperature can be in the range of 70-120° C. for e.g., 1 minute to 10 hrs, depending on the glass transition temperature of the polymer material.

In the case of nanobubbles, the thermal conductivity of air or gas incorporated in the nanobubble structure (44) is desirably reduced by the subdivision of the gas, e.g., by a factor of at least 2, preferably at least 4. The presence of nano or microbubble polymer structure (44) inside the plastic chamber (46) also provides a higher mechanical strength, enhanced by at least 50%, preferably by at least 100%, thus enhancing the resistance to deformation.

Embodiment Structure Type G: Compartmented Plastic Chamber Array Insulator Panel Filled With vacuum, Air or Heavier Gas Such as CO₂

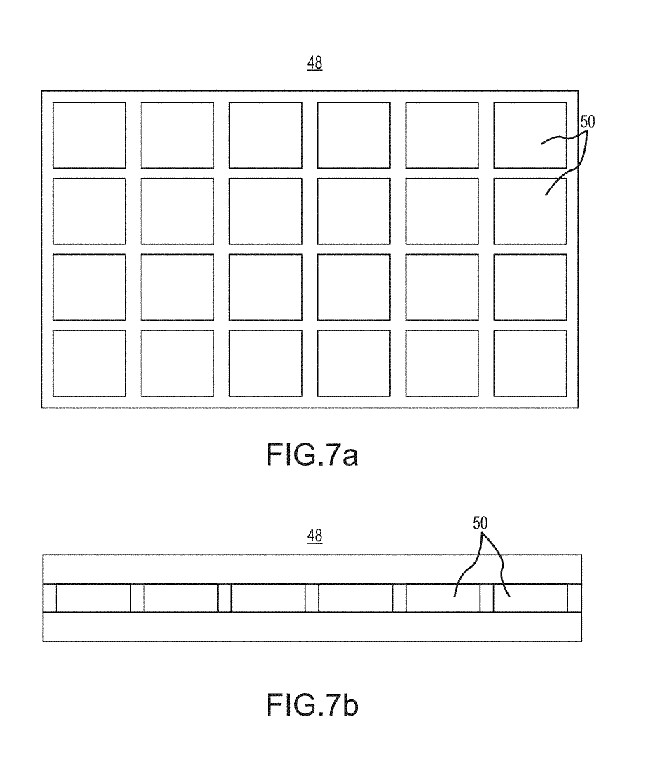

In order to obtain a highly thermally insulating, yet optically transparent, low haze window is to attach a compartmented plastic chamber array thermal insulator. Shown in FIGS. 7A-7B is a schematic illustration of a compartmented plastic chamber array (48) comprising many square or rectangular or triangular mini chambers (50) of one millimeter size to five centimeter size. The mini-chambers (50) can be filled with air, or alternatively with vacuum or CO₂ gas for reduced thermal conductivity. These mini chambers (50) can be made of some selected plastic materials such as polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and any co-polymer thereof, any combinations thereof, and any combination of these polymers with reinforcing inclusions such as particles or fibers of non-polymer materials. The closely positioned mini-chamber array (48) allows cutting to any size for retrofittable insulation of many different sizes of windows.

The micro chamber or milli chamber array (48) can be constructed by imprinting, injection molding or by inserting a pre-made grid structure between the top and bottom plastic sheets and bonding to the top and bottom plastic sheets (e.g., by heat, laser, chemical or adhesive means). The layer can be stacked to multilayer configuration if desired.

Such subdivision geometry, e.g., millimeter or centimeter size regime, can optionally be utilized as a fancy design pattern feature if desired. The scattering within a certain viewing angle might be low enough to make the glass window with such subdivisions optically reasonably transparent or translucent. Such a subdivided structure, unlike the regular dual pane glass window, can be cut into any desired window sizes for retrofit to existing windows, which is an advantageous feature. This sectionability and retrofit capability of the plastic chamber array structure (48) is a significant advantage as compared to the standard double-pane glass windows, which is difficult to handle and practically impossible to cut to a small section, having no frame structure to support, and maintain the geometry and a mechanically robust features. According to the present disclosure, the compartmented plastic chamber array insulator panel structure can be sectioned to sizes of less than 50×50 cm or equivalent area, preferably less than 30×30 cm, even more preferably less than 15×15 cm as is needed.

For vacuum pumping for enhanced thermal insulation (or pre-filled with lower conductivity CO₂ gas which has ˜⅓ less thermal conductivity than that of air), the gas filling is followed by optional vacuum pumping and sealing so that even the remaining residual gas conducts less heat.

These mini chambers (50) can be square, rectangular, hexagonal or other geometry shaped. These highly insulating chambers can also be shaped into a multilayer configuration, and can be attached onto a building window surface or wall surface by using an adhesive layer or other adhesion methods like Velcro®, zipper, or other permanent, semi-permanent or detachable mechanical attachment methods. An optional but desirable feature is to have the structures desirably optically transparent if applied to the window.

One possible manufacturing process method could be to utilize a pre-made compartment walls, millimeter size or centimeter size crossing grid array, e.g., made of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymers thereof, any combinations thereof, and any combination of these polymers with reinforcing inclusions such as particles or fibers of non-polymer materials, which can then be dropped between two plastic sheets and glued, for relatively easy processing. The layer can be stacked to produce a multilayer configuration if desired.

These sectionally compartmented, mini vacuum (or mini CO₂-filled) chambers (50) can have various geometries such as square, rectangular, hexagonal, octagon, or other shapes. These mini vacuum or mini CO₂ chamber array structures (48), if shaped into a layer configuration, can be attached onto a building window surface or wall surface by using a double-stick adhesive layer, Velcro® or other attachment structures. For window insulation, these mini vacuum or mini CO₂ chamber array structures (48) are desirably transparent to significantly enhance thermal insulation while minimally obstructing visual observation of the scenes outside the window.

The desired thickness of the plastic layer for the top face and bottom face, as well as the wall thickness is in the range of 2-1,000 μm, preferably 10-500 μm, more preferably 50-200 μm.

The desired lateral dimension of the mini chambers (50) can be selected from the range of 0.1-50 cm, preferably 0.5-20 cm, more preferably 1-5 cm. The desired height of the chamber is in the range of 0.2-200 mm, preferably 0.5-50 mm, even more preferably 1-5 mm. The desired thickness of the plastic microsheet for the wall and the top/bottom surfaces is in the range of 2-1,000 μm, preferably 10-500 μm, more preferably 50-200 μm. The mini chamber layer can be stacked to a multilayer structure up to 10 layers.

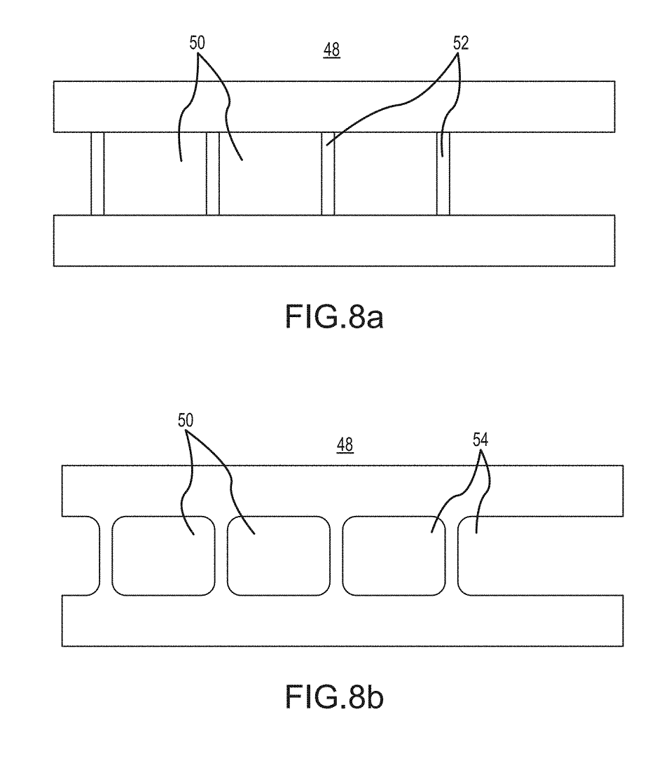

The sharp corners where the vertical walls meet the top or bottom panels could cause optical discontinuity and could contribute to the haze if not properly designed. Therefore, these corners can be optionally rounded, as depicted in FIG. 8B, according to the present disclosure, so as to make the structure more transparent. The method of producing the rounded corner walls (54) can be either heat-guided thermoplastic deformation or chemical reaction induced. A pre-made wall array (e.g., square, rectangular, hexagonal, oval or honeycomb shape) can also be dropped between the top and bottom panels, and then thermally, chemically, or adhesively bonded with the heat or chemical reaction concentrated near the corner to induce less sharp corners. This is illustrated in FIGS. 8A and 8B, both of which show a cross-sectional view of plastic mini chamber array insulators (48) for window (e.g., made of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and any co-polymer thereof, any combinations thereof, and any combination of these polymers with reinforcing inclusions such as particles or fibers of non-polymer materials) comprising mini vacuum-filled or CO₂-filled chambers (50), with FIG. 8A depicting straight vertical walls (52) from the same plastic material, and FIG. 8B depicts corner-rounded vertical walls (54) from the same plastic. A mixed use of different plastics, e.g., PEN for top and bottom panel, and PET wall is not excluded. PET, PBT, PEN and other plastic can be utilized for the construction of mini vacuum or CO₂-filled chambers.

Embodiment Structure Type H: Construction of Plastic Chamber Insulator with Pre-Made Grid Insertion

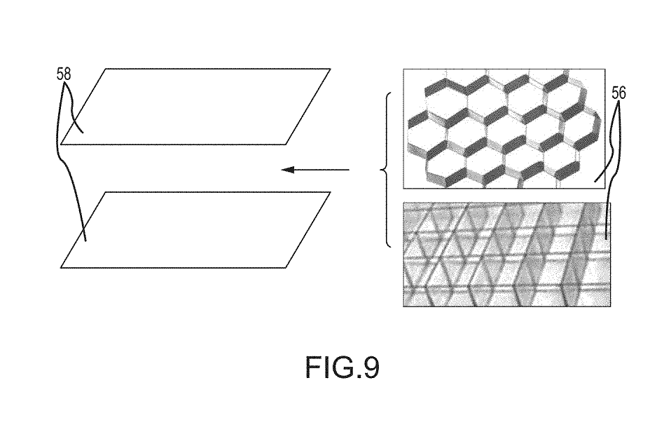

One possible manufacturing process method is to utilize pre-made compartment walls, millimeter size or centimeter size crossing grid array (56), e.g., made of a preferred polymer material selected from a list of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymer thereof, any combinations thereof, and any combination of these polymers with reinforcing inclusions such as particles or fibers of non-polymer materials. The grid layer structure (56) can then be dropped between two plastic sheets (58) and heat-bonded, chemical bonded or adhesively bonded onto the top and bottom plastic sheets above and below for relatively easy processing, as illustrated schematically in FIG. 9.

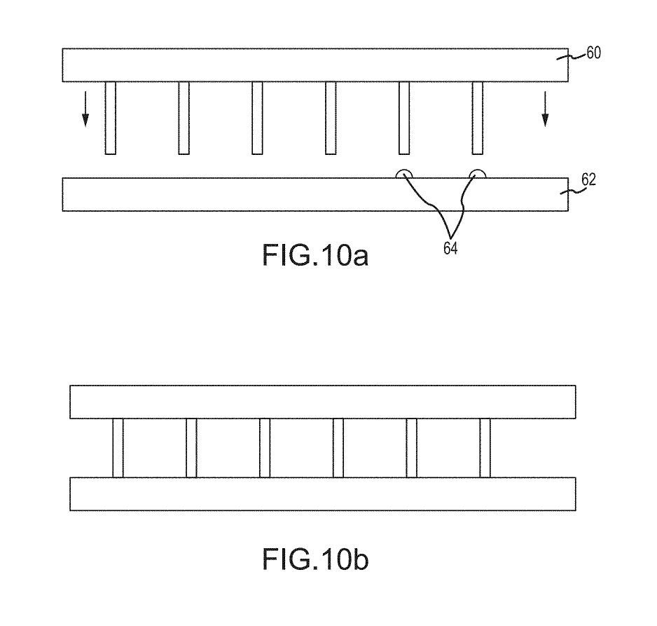

Pre-made plastic walls of PET, PBT, PEN, PI, etc. can be inserted between the top and bottom plastic panels and assembled into a mini chamber array structure by thermal, chemical or adhesive bonding. Shown in FIGS. 10A-10B is an assembly of mini-vacuum chamber array using a pre-made and one side pre-attached plastic walls of PET, PBT, PEN, PI, etc which can have either straight wall or corner-rounded wall. In FIG. 10A, the one side pre-attached structure (60) is lowered onto the bottom panel (62) for attachment. In FIG. 10B, bonding of the vertical wall ends and the bottom panel is carried out using laser or IR heat wave, either blanket heating or localized heating aimed at the contact points. Regular electrical or other heater can also be used to heat the bottom panel to near T_{g} temperature to soften the plastic for easier bonding and corner rounding. Chemical or adhesive bonding can also be utilized. Additionally, optional pre-attach of a plastic piece or precursor (64) as a small bowl may be used for ease of bonding. The pieces (64) can also be pre-attached to the bottom edge of the vertical sheet.

Embodiment Structure Type I: Addition of Low-emission Coating, or Total Replacement of Glass Window with Plastic Chamber Insulator

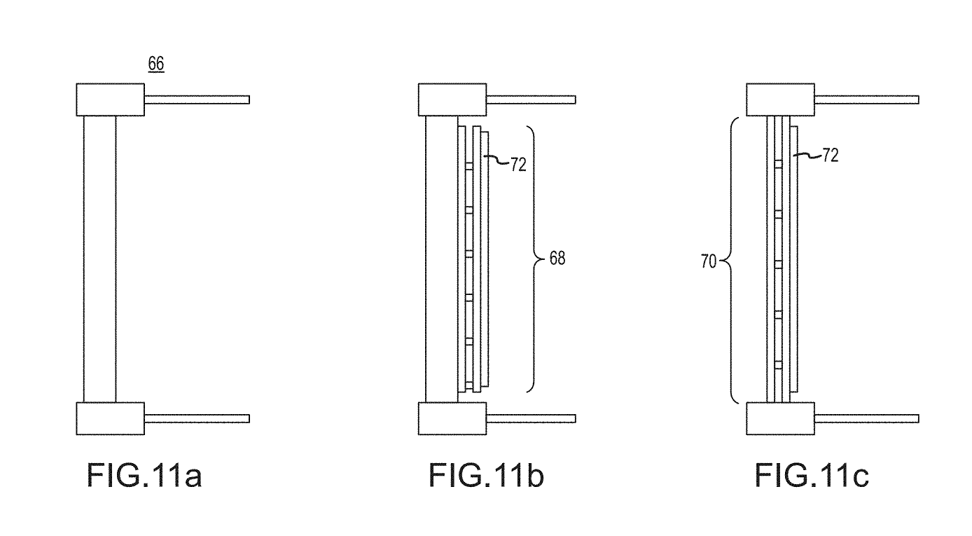

The highly thermally insulating plastic chamber structure can be utilized for energy savings by either i) as an attachment (68) (FIG. 11B) onto the existing glass window (66) (FIG. 11A), or ii) as a window material by itself (70) replacing the glass window (66) completely, as illustrated in FIG. 11C. The insulating laminate, either a one-chamber panel structured or mini-chamber-array structured, and either single layered or multilayered insulators can be applied to the inside (or outside) surface of glass window for enhanced thermal insulation.

The use of low-emission coating (72) such as highly IR-reflective layer of thin metals or indium-tin-oxide type layers is optional. The low-emission coating (72) can be applied preferably on the inside surface of the plastic chamber layer facing the indoor side, so as to minimize the emission loss of indoor heat.

One or more of mechanically wear resistant coating (72) or superhydrophobic/superomniphobic coating may also be employed to further enhance the durability/reliability/maintainability of the panel surface, according to aspects of the present disclosure.

The use of wear resistant, transparent ceramic coating (72) (which can also be made omniphobic) on the plastic chamber surface, according to the present disclosure, also enables the plastic surface to last longer with minimal scratches and dirt or finger print accumulation, and also provides a cleanability with typical glass-window-cleaning solutions such as the Windex spray. The surface mechanical hardness of the wear resistant, transparent ceramic coated plastic chamber insulator is made to increase to at least H=5, preferably at least H=7. The H scale is the pencil tip scratch hardness testing scale according to the ASTM standard.

FIGS. 11A through 11C depict different ways of utilizing the highly thermally insulating, plastic mini chamber array laminate, (a) traditional glass window, (b) the insulating laminate, single layered or multilayered chamber layers applied to the inside (or outside) surface of glass window for enhanced thermal insulation, (c) highly thermally insulating mini chamber array laminate can also be used as the window replacing the glass-based windows completely.

### Embodiment Structure Type J: Rigid Support Framed Plastic Chamber Insulator

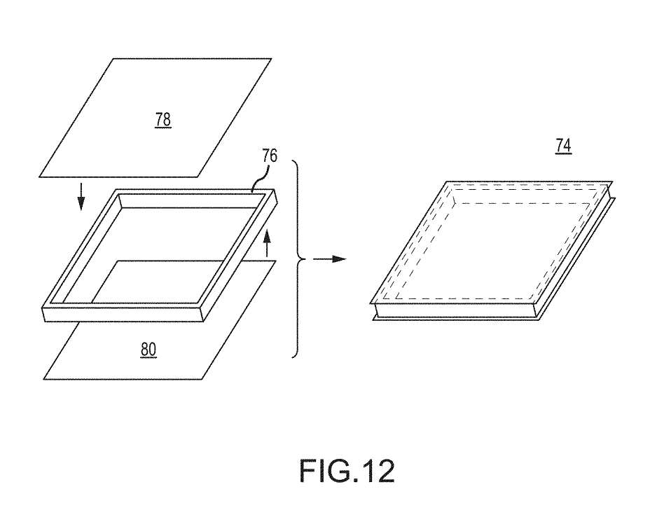

Shown in FIG. 12 is an embodiment of a dual-pane plastic insulator chamber (74) with the interior of the chamber filled with a heavy gas like CO₂ or pumped to a vacuum state of less than 10⁻¹ torr level. Either a simple picture-frame shaped edges of thicker plastic material (76), or the edges pre-attached to the subdivided internal grid walls (preferably made of a similar plastic) (not pictured), can mechanically support the upper (78) and the lower (80) plastic sheet panels to maintain reasonably flat and inflated condition. The desired thickness of the plastic layer for the top face (78) and bottom face (80) is in the range of 2-1,000 um, preferably 10-500 um, more preferably 50-200 um. The preferred plastic layer material is selected from a list of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymer thereof, any combinations thereof, and any combination of these polymers with reinforcing inclusions such as particles or fibers of non-polymer materials.

### Embodiment Structure Type K: Internal-Spacer-Array Supported Plastic Chamber Insulator

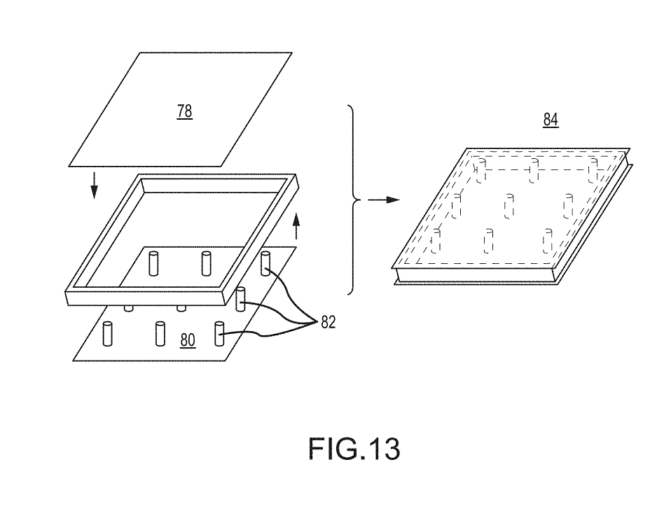

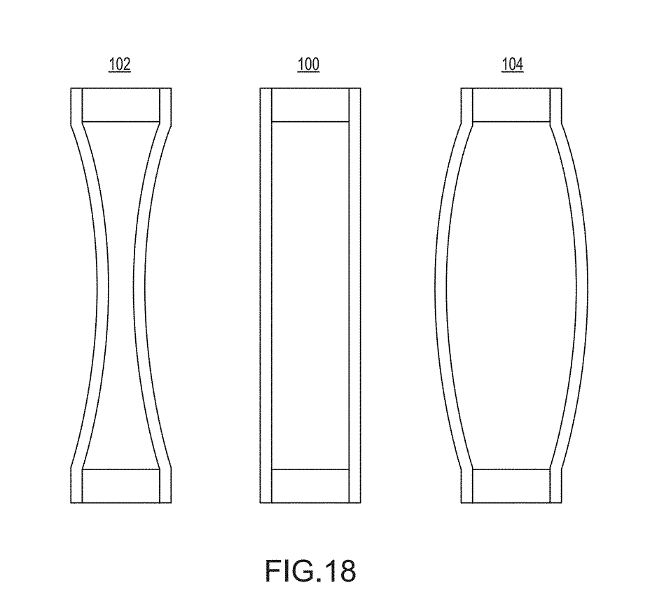

When the flat chamber insulator (74) has a large area, e.g., greater than 50×50 cm size, the thin plastic sheets (78, 80) might change shape and cause concave distortion especially if the temperature gets cold, as illustrated in FIG. 18. Therefore, the present disclosure discloses a structural arrangement of providing periodic (or non-periodic) distribution of spacer islands (82), e.g., 0.1-5 mm diameter pillars, preferably 0.2-2 mm diameter, more preferably 0.5-2 mm, which will serve as mechanical supports to prevent the partial inward collapse of the thin plastic sheets, as illustrated in the spacer array (82) reinforced embodiment of a plastic chamber construction (84) of FIG. 13. The density of the pillars is at least 4 pillars, preferably at least 16 pillars, more preferably at least 100 pillars per unit area of 100×100 cm.

The spacer pillars (82) can have circular, oval, square, rectangle, or other geometry cross-sectional shapes. These spacer pillars (82), preferably made of the same material as the upper and lower sheet plastic (but using a different plastic is not excluded), can be pre-attached to one of the two plastic panel sheets (78, 80) before assembly into the chamber insulator structure (84). For construction/attachment of various parts, thermal, chemical or adhesive bonding can be used to form the chamber. Vacuum, air or CO₂ filling can be employed for the interior of the plastic insulator chamber, with a small, optional gas filling/refilling port attached. The preferred plastic layer material as well as the plastic spacer material is selected from a list of polymethylmethacrylate (PMMA), polyethylene terephthalate (PET), Polyethylene naphthalate (PEN), Polybutylene terephthalate (PBT), Polyamide (PA), Polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK) and co-polymer thereof, any combinations thereof, and any combination of these polymers with reinforcing inclusions such as particles or fibers of non-polymer materials.

As the plastic chamber is sealed, the air pressure or CO₂ pressure is maintained within the chamber insulator, and hence the basic flatness of the insulator is generally maintained, especially if the pressure is somewhat positive relative to the air atmosphere.

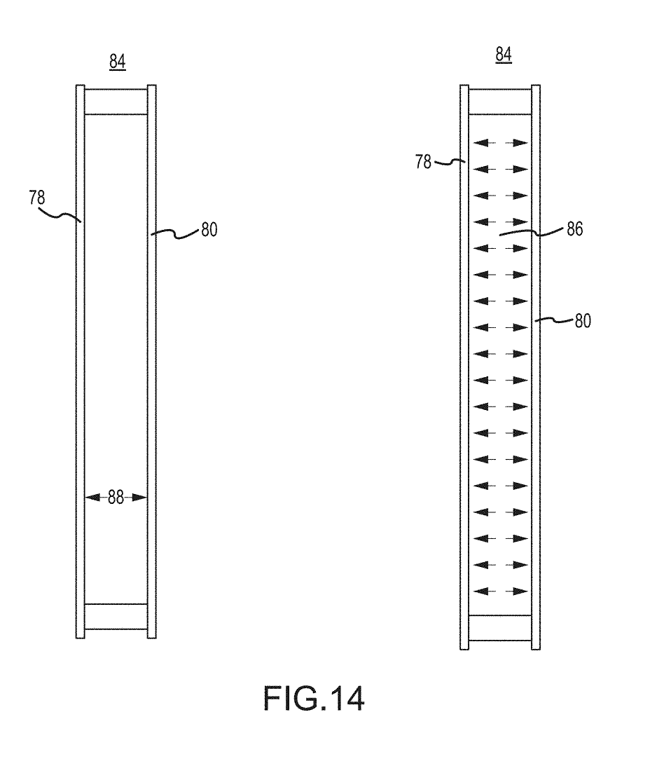

The cross-sectional views of the plastic chamber insulators are shown in FIG. 14. The plastic chamber, after it is filled with vacuum or CO₂ gas, is sealed. Therefore, the air pressure or CO₂ pressure (86) within the chamber is kept the same, and hence the basic flatness of the insulator is generally maintained, especially if the pressure is somewhat positive relative to the air atmosphere.

The desired thickness of the plastic sheet or foil layer (78, 80) like PET in the plastic chamber insulator (84) is in the range of 2-1,000 um, preferably 10-500 um, more preferably 50-200 um. The desired gap distance (88) (filled by vacuum, air or CO₂ gas) between the two plastic layers in the plastic chamber insulator is, e.g., in the range of 0.2-200 mm, preferably 0.5-50 mm, even more preferably 1-5 mm. If the ratio between the thickness of the plastic sheet or foil material (78, 80) and that of the gas layer (88) is made to be very small (e.g., 1:10 ratio), the thermal conduction contribution of the plastic material portion becomes much smaller and hence the overall thermal conductivity will approach the value of the gas layer (e.g., air or CO₂). If the thicknesses of the plastic and the gas layers are comparable to each other, the thermal conductivity of the panel will be the average of the two materials (plastic vs or CO₂). There are many polymer candidates but PET is one of the preferred choices because it can prevent CO₂ from leaking for a long time as has been demonstrated in the somewhat pressurized soda type bottled beverage articles.

There are various advantages associated with the use of the thin and flexible plastic chamber insulators of this disclosure, for the insulation of glass windows and other applications.

The plastic chamber insulators (84), according to the present disclosure, exhibit a desirably reduced thermal conductivity as compared to the value for the soda-lime glass (K˜1.15 W/mK, which represents a fairly good thermal conductor with its K value much larger than that for air with K˜0.024 W/mK) typically used for single pane glass windows. The K values of the chamber insulators vary depending on the geometry and structure, whether vacuum, CO2 or air is filling the chamber, and how many layers are present in the multi-layer structures. The thermal conductivity values of the plastic chamber insulators, according to the present disclosure, is in the range of 0.01-0.08 W/mK, preferably in the range of 0.02-0.06 W/mK, even more preferably in the range of 0.02-0.05 W/mK, which represents a reduction of thermal conductivity compared to that of glass by a factor of at least 10, preferably by a factor of at least 20, even more preferably by a factor of at least 50.

The plastic chamber insulators (84), according to the present disclosure, are optically transparent, with the transmission in the visible range of at least 80%, preferably 85%, even more preferably 90%, and the optical scattering haze of less than 10%, preferably less than 5%, even more preferably less than 2%.

The plastic chamber insulators (84), according to the present disclosure, are generally made mechanically flexible (in part due to the thinness of the plastic layer involved, and in part due to the presence of gas inside) and can accommodate stresses/strains and thermal distortions. Such a mechanical flexibility is not available in the case of rigid glass pane (single or double pane) or rigid plastic pane.

The plastic chamber insulators (84), according to the present disclosure, are very light, thus can easily be handled by ordinary household persons and can be retrofitted on existing single-pane glass windows in a convenient manner. If total 3 mm thick chamber is made, both surface plastic layers together can take a thickness of (300 μm×2) thick while 2.4 mm thick space in the middle can be filled with air or CO₂. The weight of the plastic chamber insulator (84) is dependent on whether there is vacuum, air or CO₂ within the chamber, and how many layers are there in the case of multilayer chamber structure, but the density of the plastic chamber insulator, according to the present disclosure, is reduced by at least 40%, preferably by at least 70%, even more preferably by at least 90% as compared to the weight of the typical glass windows with an identical volume.

### Embodiment Structure Type L: Multi-Layered Plastic Chamber Construction

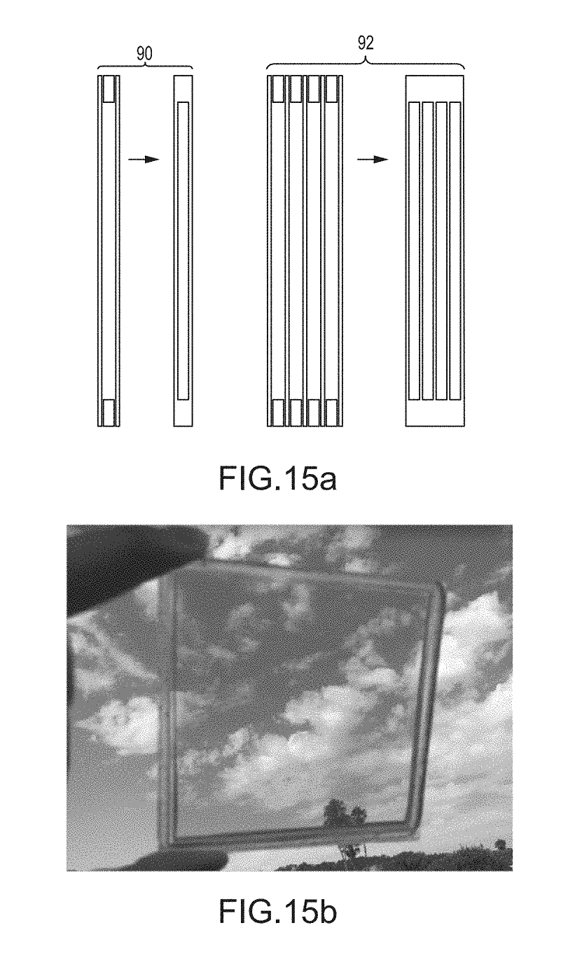

Shown in FIG. 15A is a method of seamless welding of the edges of either single layer plastic chamber insulator (90) or multiple layered chamber insulators (92), by heating the plastic to the plastic softening temperature near the glass transition temperature Tg (via convection, radiation, hot air blow, laser, IR, etc), optionally utilizing some compressive force to aid the bonding process. Other methods such as chemical bonding (e.g., using ethylene dichloride solvent for PMMA acrylic plastic) or adhesive bonding using epoxy-based adhesives, urethane-based adhesives or various other adhesive polymers.

According to the present disclosure, multi-layered plastic chamber insulators (92) (containing air or CO₂ gas) exhibit superior insulator properties compare to a thick single layer chamber insulators (90) having an identical total thickness. The high aspect ratio of the air space (smaller chamber gas thickness to width ratio) minimizes convection, so subdivided gas space thickness is beneficial. If the thickness of the air gap is too thick, the convection in the gas space increases heat transfer between the inside and outside of the window.

In this disclosure concerning plastic chamber insulators, typically a gas space thickness thinner than 10 mm, preferably less than 5 mm is desirable to make the effect of convection less significant even the temperature difference of cold side and warm side is as large as ˜50° C. Therefore, a multi-layer stacked chamber insulator having a more powerful convection-reducing structure with an individual chamber gas layer thickness of less than ˜2 mm is even more preferred.

An example see-through insulator structure comprising a 250 μm PET double layer chamber is depicted in FIG. 15B. The structure depicted in FIG. 15B is 10 cm×10 cm×5 mm thick. The exemplar plastic chamber insulator was constructed as follows. Two layers of PET sheet, each 250 μm thick, 10 cm×10 cm dimension, were put together with a PET spacer between the two sheets at 5 mm thickness. The assembly was done by using a glue material of ClearWeld™ Quick-Setting Epoxy, a very thin, ˜10 μm thick glue layer at room temperature and cured for 20 minutes. The interior of the chamber was filled with air, sealed using a glue and the pressure was maintained at 1 atmosphere. The chamber was positioned vertically and was clearly see-through, and highly thermally insulating. The optical transparency was estimated to be ˜90%, and the haze was estimated to be less than less than 2%. The thermal conductivity of the chamber through the thickness direction was estimated to be K=0.028 W/mK. The weight of the chamber was 14 grams, much lighter than the same dimension dense acrylic solid plastic sheet, 64 grams (measured value), and is even lighter than the same lateral size glass sheet dual panel structure having a glass thickness of 1 mm, 96 grams.

Another example plastic chamber insulator in the form of multilayered chamber is constructed as follows. Four layers of PET sheet, each 25 μm thick, 1 meter×1 meter dimension, are put together with a spacer between the two sheet of 4 mm thickness. The assembly is done by using a glue material of ClearWeld™ Quick-Setting Epoxy, ˜10 μm thick glue layer at room temperature and cured for 20 minutes. The interior of the chamber is filled with CO₂ gas and sealed, and the pressure is maintained at ˜1.2 atmosphere. The chamber is positioned vertically and is clearly see-through, and highly thermally insulating characteristics. The optical transparency is estimated to be at least ˜85%, and the haze is estimated to be less than 5%. The thermal conductivity of the chamber through the thickness direction is estimated to be K=0.019 W/mK.

### Embodiment Structure Type M: Plastic Chamber Insulator Attachment on Raised Edges to Prevent Trapped Air Bubble and to Minimize Thermal Distortion.

Air bubbles trapped in the adhesive layer while applying the film to the surface are difficult to remove once they are formed.

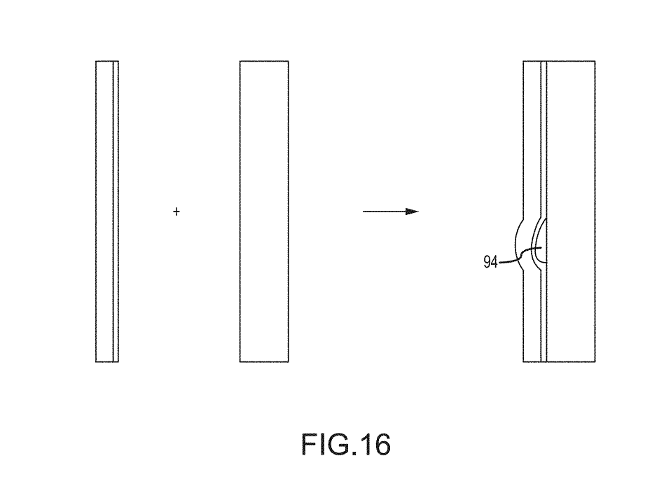

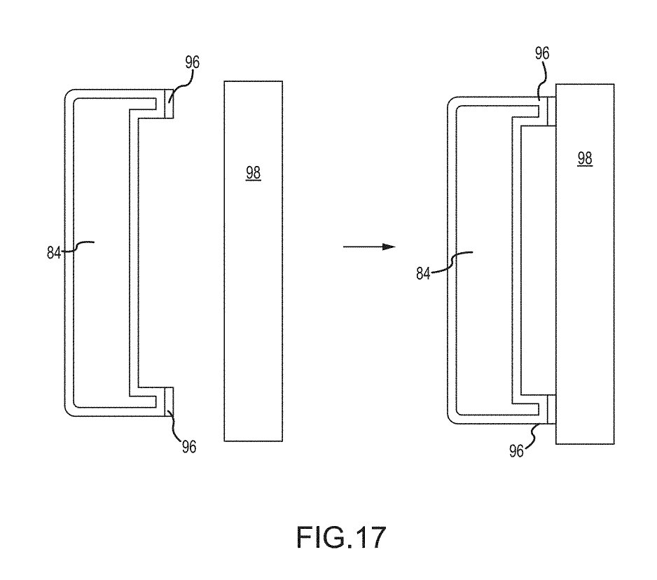

The plastic chamber layer insulator in this disclosure is made of thin plastic sheets and is mechanically compliant. The chamber insulator of this disclosure needs to be firmly attached onto the glass window for building energy saving purpose. While one of the faces of the insulator can be coated with adhesive polymer and attached onto the glass surface, such adhesive coated surface sometimes causes air bubble (94) trapping on application of the film to the glass, as shown in FIG. 16. The air bubbles (94) are difficult to remove once they are formed at the interface. In addition, the temperature differential that arises in the winter season between the two plastic sheets of one attached on the cold glass (thus having a lower temperature) and the other facing the heated interior of the room (thus having a much warmer temperature) creates a differential thermal expansion/contraction behavior which will distort the plastic chamber insulator. Therefore, one of the embodiments to solve these problems is to attach the plastic chamber insulator on the raised edges (96) only (with the raised edge (96) on the chamber insulator or on the glass window, e.g., by using a thicker adhesive structure), as shown in FIG. 17. An additional benefit is that there is an extra air gap insulating space created between the plastic chamber insulator (84) and the window glass surface (98) for enhanced thermal insulation.

Instead of adhesive bonding, Velcro®, zipper, button, hooks or hanging ledges can also be used. An additional air gap is created between the plastic chamber insulator (84) and the glass window for enhanced thermal insulation.

### Embodiment Structure Type N: Use of Flexible Attachment Connection of Plastic Chamber Insulator to the Glass Window to Accommodate Thermal/Mechanical Strains

The plastic chamber insulator filled with air or CO₂ gas and sealed (100) will contract at low temperatures (102) and expand when it is hot (104) (e.g., in summer days), as illustrated in FIG. 18. The expected contraction or expansion of gas-filled or vacuum-filled plastic dual pane insulator chamber, will cause a distortion of the plastic chamber insulator shape, and pose a problem of how to maintain a reasonable flat geometry during temperature change.

Plastic chamber sheets like those made of PET will have a higher coefficient of thermal expansion (CTE) or contraction than the regular window glass. The thermal expansion/contraction mismatch will tend to make the plastic sheet to curve, so it is important to provide a mechanism to absorb this mismatch effect.

Furthermore, as there is often a large temperature gradient in the winter season between the cold outside vs warm indoor environment through the glass window, the two plastic layers of the chamber insulator will have a substantial temperature difference, for example, −20° C. in the PET layer facing the outdoor direction vs +20° C. in the PET facing the indoor direction. There is a need to compensate a volume change of ±10% on weather variation or room environmental temperature change. This can be anywhere between −20° C. and +40° C. Such a differential temperature causes an asymmetric distortion of the plastic insulator chamber. Using the equation PV=nRT, if P inside is constant, the minimum volume/maximum volume ratio=(−20+273)/(40+273)=0.8. Therefore, a new design of the plastic chamber insulator has been provided, according to the present disclosure. Such strain accommodating device structures are described in the following embodiments.

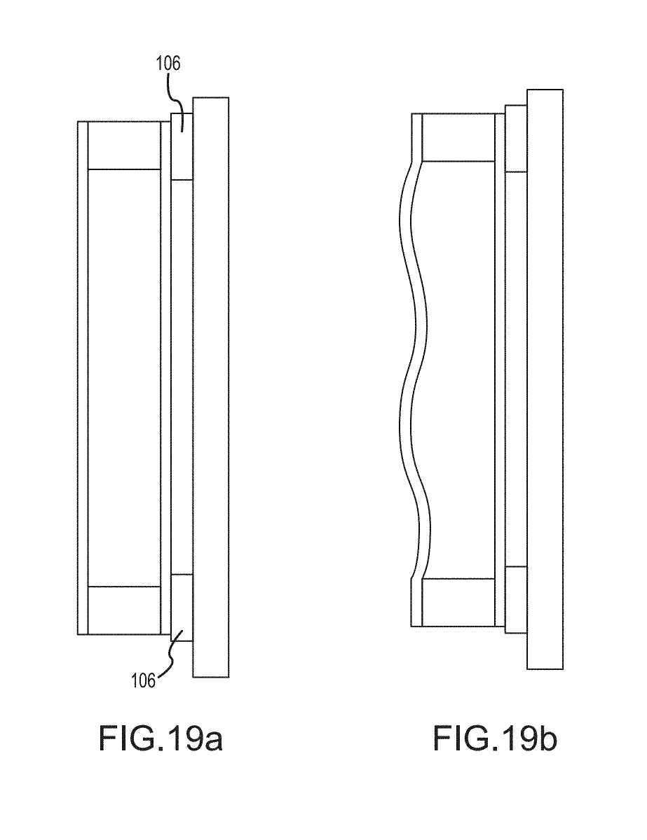

Plastic chamber sheets like those made of PET will have a higher coefficient of thermal expansion (CTE) or contraction than the regular window glass. The thermal expansion/contraction mismatch will tend to make the plastic sheet to curve, so it is important to provide a mechanism to absorb this mismatch effect. The designs in FIG. 19 illustrate two mechanisms by which the thermal distortion can be reduced. Shown in FIG. 19A is an attachment scheme based on flexible structures (106) like velcro type, zipper type, press-on button or other mechanical mechanisms which can mitigate the thermal distortion problem. Alternatively, one or both surfaces of the plastic chamber can be made curvatured or corrugated, as illustrated in FIG. 19B, to accommodate the temperature-induced or temperature-gradient-induced thermal expansion/contraction and associated CO₂ or air volume change within the plastic chamber insulator. These structures also provide an extra air gap insulation between the plastic chamber insulator and the window glass. Flexible attachments like velcro type, zipper type, press-on button or other mechanical mechanisms may be used to mitigate this problem. Alternatively, one or both surfaces of the plastic chamber can be made curvatured or corrugated to accommodate thermal expansion/contraction and associate CO₂ or air volume change within the plastic chamber insulator. These structures also provide an extra air gap insulation between the plastic chamber insulator and the window glass.

### Embodiment Structure Type O: Use of Flexible Corrugated Plastic Extension to Connect Plastic Chamber Insulator to the Glass Window to Accommodate Thermal/Mechanical Strains

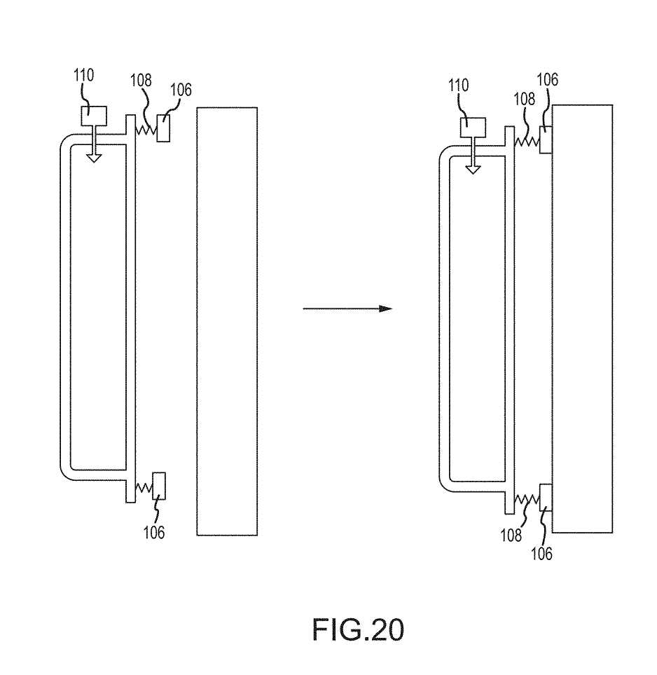

Another embodiment to accommodate the thermal distortion/strain is to utilize a design comprising flexible plastic connector material (108) such as corrugated plastic sheet, plastic spring or other mechanically compliant structures, as shown in FIG. 20. An extra air gap insulator layer is also created in this design to further assist in the thermal insulation of the glass window. A vacuum or CO₂ fill/refill port (110) can optionally be added onto the plastic chamber.

### Embodiment Structure Type P: Use of Volume Compensator to Plastic Chamber Insulator to Accommodate Thermal/Mechanical Strains

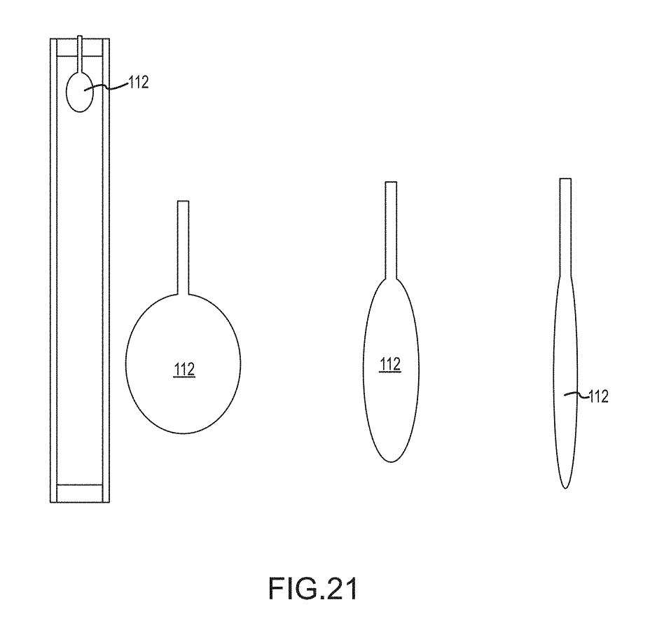

The volume change problem by thermal expansion or contraction of the filled air or CO₂ in the plastic chamber insulator can be mitigated with an addition of the volume compensator (112) having a valve structure shown in FIG. 21. The volume compensator (112) is like a balloon that can shrink or expand to accommodate the temperature change induced gas expansion or contraction within the plastic chamber insulator. The material for the volume compensator (112) can be the same optically transparent plastic (such as PET, PBT, PEN, PMMA, PI, etc). The structure of the volume compensator (112) can be like a corrugated plastic bag or a folded and partially sealed plastic container. The thickness of the plastic sheet in the volume compensator (112) can be made slightly thinner than that for the plastic chamber insulator, so as to make the volume compensator (112) respond first to the pressure change and enable a deformation to accommodate the volume change and to keep the plastic chamber insulator to maintain the generally flat geometry with essentially the same overall appearance.

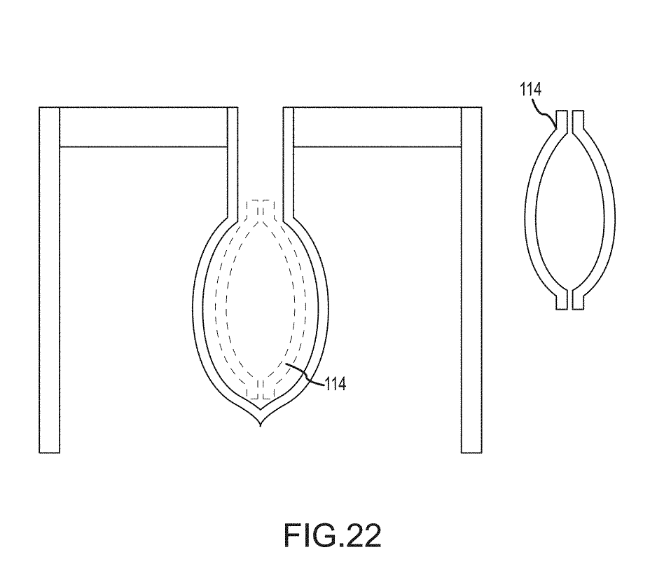

A negative CTE (coefficient of thermal expansion) structure (114) made of metal or polymer can also be utilized so that when the temperature rises to expand the gas volume, the shape changes to reduce its volume, and vice versa, as shown in FIG. 22. The negative CTE structure (114) (e.g., a bilayer ribbon comprising Ni—Ti phase transformation alloy) flattens as the temperature increases to deflate the balloon and curves up to inflate it as the temperature decreases. It is filled with a heavy gas. In an example embodiment, it can be filled with carbon dioxide. In an alternative example embodiment, it can be filled with argon. In an additional example embodiment, it can be filled with sulfur hexafluoride.

The volume compensator device (112, 114) attached to the plastic chamber insulator, according to the present disclosure, is capable of accommodating a volume change caused by temperature variation or other effects while maintaining the flatness of the insulator. The desired amount of volume compensation is in the range of amount of 2-30%, preferably 5-20%, even more preferably 5-15%.

### Embodiment Structure Type Q: Use of Volume Compensator to Plastic Chamber Insulator to Accommodate Thermal/Mechanical Strains

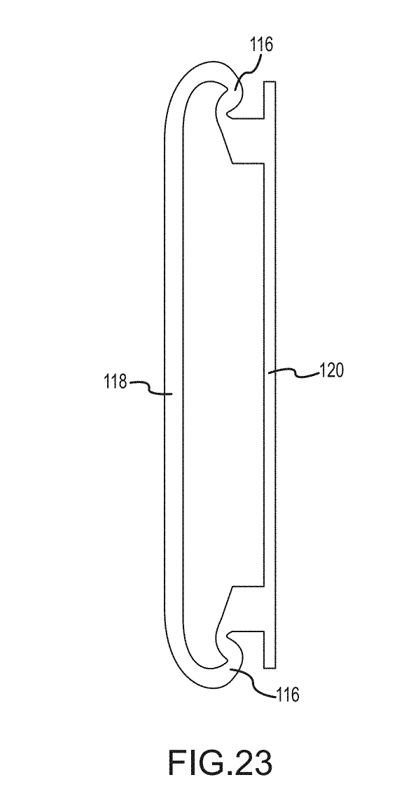

Shown in FIG. 23 is an alternative method of compensating the volume shrinkage on temperature change using a repeatably deformable portion (116) of the plastic chamber insulator wall structure. As the deformable section (116) of the plastic wall is made thinner, this portion responds first to the change in volume and change the shape to absorb the air or CO₂ volume expansion or contraction on temperature change or temperature-gradient-change. This accommodation keeps the shape of the flat face portion of the plastic chamber insulator basically unchanged so that the appearance and viewing is less affected.

The outer plastic sheet (118) is made fairly thick (at least 200˜300 μm). Even if this sheet bends slightly, the radius of curvature will be large enough to be less noticeable. The inner plastic sheet (120) will be attached to the glass window by adhesive or Velcro® means and its shape will be mostly maintained for thin sheet geometry even if the gas volume shrinks. In an example embodiment, only a portion of the inner plastic sheet (120) will be attached to the glass window. The repeatably deformable portion (116) will be made intentionally thinner (50˜100 μm) than the outer sheet (200˜300 μm) so only the deformable portion can shrink when the chamber gas volume shrinks. The thinner deformable section (116), together with of the thicker plastic wall in the rest of the plastic, can be easily produced by injection molding method for large-scale production.

### Embodiment Structure Type R: Use of Gas Fill/Refill Port to Control the Gas Amount/Pressure

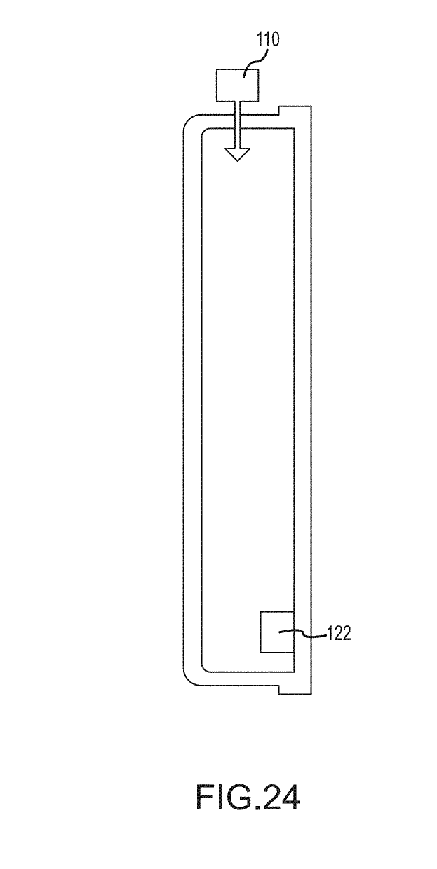

Depicted in FIG. 24 is an optional use of a fill or refill port (110) to adjust the gas pressure or vacuum level inside the plastic chamber insulator. A leak detector (122) (e.g., thin-printed or sticker type) can also be included to be attached on the inside wall for detection of the heavy gas level such as the CO₂ concentration. If there is a leak of CO₂, the outside air comes inside the chamber and the leak detector (122) will generate a warning signal or display so that the gas can be replaced or replenished to the right concentration level of the intended gas. The fill//refill port (110) can also be used as a vacuum port if a vacuum state is to be utilized in the plastic chamber insulator. At 300K, 1 bar, thermal conductivity of various gases are: K(air)=0.0262 W/mK; K(Ar)=0.0179 W/mK; K(CO₂)=0.0168 W/mK; K(sulfur hexafluoride)=0.013 W/mK; and K(xenon)=0.005 W/mK. It should be noted that there is only a tiny amount of Xenon in the earth's atmosphere.

### Embodiment Structure Type S: Shaped Half-Shell Plastic Attach to Form an In-Situ Chamber Insulator

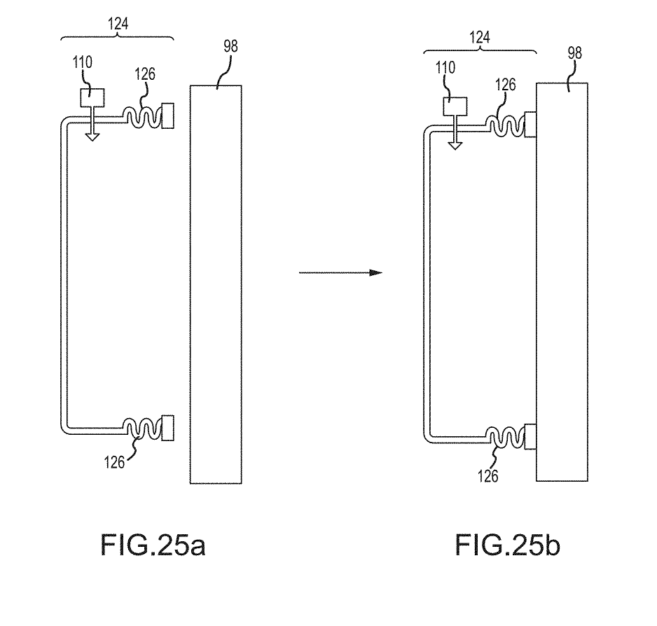

Instead of a fully assembled plastic chamber insulator, an alternative approach is to spend only one half of the chamber component and stick it onto existing glass to in-situ form an insulating chamber, as illustrated in FIGS. 25A and 25B. Here, a half-shell plastic chamber structure (124) (which optionally contains a gas fill/refill port (110) is prepared so that it is ready to be attached onto existing window glass surface (98) using adhesive bonding, FIG. 25A. The half-shell plastic chamber structure (124) desirably has some of its portion to be shaped like a flexible corrugated or springy geometry (126) so that thermally-induced or thermal-gradient-induced shape expansion/contraction and related distortions are accommodated. After the half-shell is attached, it is followed by CO₂ filling and sealing to complete the plastic chamber insulator, FIG. 25B. The plastic chamber so formed operates as an excellent thermal insulator. The flexible connect (e.g., corrugated or other flexible plastic components) accommodates thermal expansion related distortions and stresses.

### Embodiment Structure Type T: Construction Method for Plastic Chamber Insulator by Two Parts Bonding or One Part Injection Molding

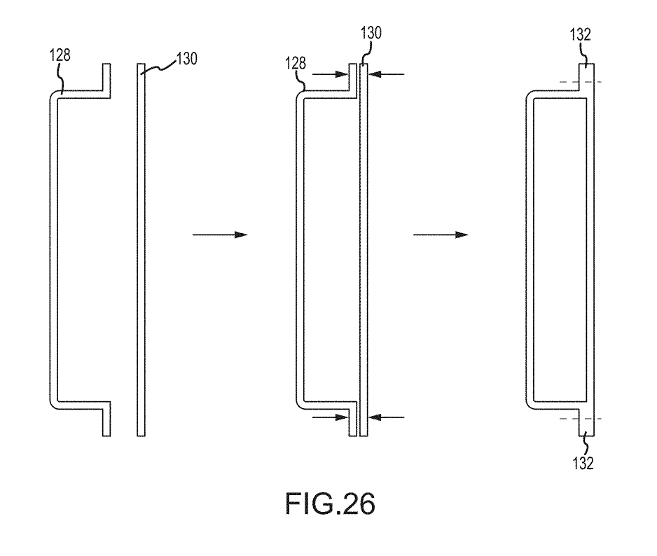

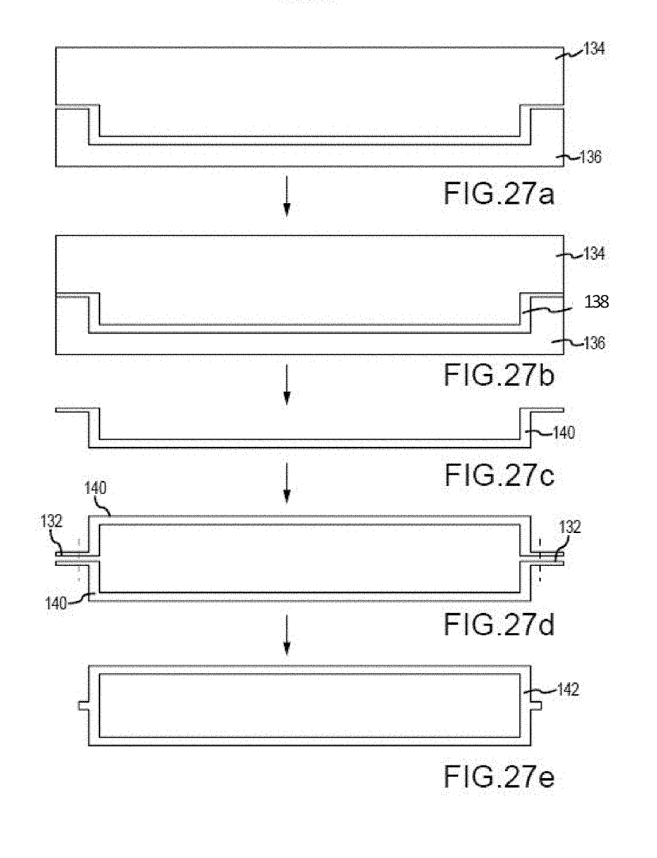

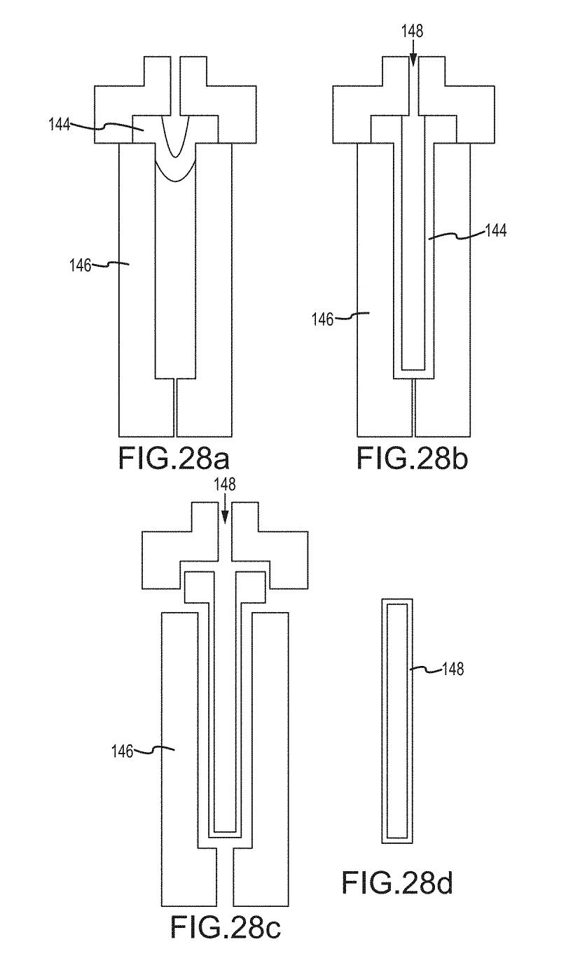

For construction of the plastic chamber insulator, either two parts bonding method or a single part injection molding fabrication can be used. Shown in FIG. 26 is an example method of bringing two parts of the plastic (128, 130) and bonding to form the chamber, using heat bonding, chemical bonding or adhesive bonding. In this example method, the two plastic sheets (128, 130) are brought together and bonded by pressing and heating, then the excess amount of the bonded edges (132) is trimmed. Optionally, a third component, e.g., a spacer plastic part can also be used between the two plastic components (128, 130) during bonding. Heat bonding, chemical bonding or adhesive bonding are some of the common methods to attach plastic components. For heat-induced bonding, a torch, laser beam, radiated heat, hot air blower, IR heater, concentrated solar beam, etc. can be utilized. The shaping of plastic sheets such as PET or PMMA (acrylic), PBT, PEN or PI can be done either by local heating and bending of a flat sheet, or by injection molding as illustrated in FIGS. 27A-27E. In this example method, two-part heated injection molds (134, 136) are injected with thermoplastic polymer (138), leaving a shaped plastic (140) after removal from the mold. The thermoplastic polymer (138) may be PET or plexiglass, or other type of thermoplastic polymer. Two of the shaped plastic parts (140) are brought together, filled with a heavy gas, and the chamber is sealed by heat. Then the excess materials on the sealed edges (132) are cut off to complete the filled chamber (142). An injection molding to form the complete chamber shape, as illustrated in FIGS. 28A-29D, is a convenient and inexpensive method amenable to industrial scale manufacturing. In this example method, a pre-shaped thermoplastic (144) is mounted to the heated mold (146), then hot air is blown into the mold (148) to expand the thermoplastic (144) and shape it to the desired dimension. The mold is then opened, the formed shape (148) released, and the chamber filled with a heavy gas, then the opening into which the gas is filled is closed to seal the chamber.

### Additional Embodiments

As detailed herein, a thermally insulating article comprising a plastic chamber structured insulator is disclosing having a thermal conductivity of less than 0.10 watt/m.K, preferably less than 0.05 watt/m.K, even more preferably less than 0.03 watt/m.K. In embodiments, the insulator has a configuration of at least two horizontally parallel micro plastic sheets with the edges sealed and filled with vacuum, air or CO₂ gas. In embodiments, the insulator has an optical transmission in the visible range of at least 80%, preferably 85%, and even more preferably 90%, and the optical scattering haze of less than 10%, preferably less than 5%, and even more preferably less than 2%. In embodiments, the insulator has a the weight that is reduced by at least 40%, preferably by at least 70%, even more preferably by at least 90% as compared to the weight of typical glass windows of identical volume.

In embodiments, the plastic material is selected from a list of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymers thereof, any combinations thereof, and any combination of these polymers with reinforcing inclusions such as particles or fibers of non-polymer materials.

In embodiments, the insulator structure detailed herein is mechanically flexible and bendable without breaking at a radius of curvature of at least 200 cm, preferably at least 100 cm, even more preferably at least 50 cm. In embodiments, the insulator comprises horizontally parallel micro plastic sheets which constitute a single layer chamber. In embodiments, the insulator comprises a dimension of a desired thickness of the plastic sheet in the plastic chamber insulator in the range of 2-1,000 μm, preferably 10-500 μm, more preferably 50-200 μm. In embodiments, the desired gap distance (filled by vacuum, air or CO₂ gas) between the two plastic layers in the plastic chamber insulator is, e.g., in the range of 0.2-200 mm, preferably 0.5-50 mm, even more preferably 1-5 mm.

In embodiments, the horizontally parallel micro plastic sheets constitute a multi-layer stacked chambers with at least 2 chamber layers, preferably at least 5, even more preferably at least 10 chamber layers.

In embodiments, the plastic chamber insulator structure comprises a chamber that is laterally compartmented. In embodiments, the desired lateral dimension of the mini compartmented chambers selected from the range of 0.1-50 cm, preferably 0.5-20 cm, and more preferably 1-5 cm. In embodiments, the desired height of the chamber is in the range of 0.2-200 mm, preferably 0.5-50 mm, even more preferably 1-5 mm. In embodiments, the desired thickness of the plastic microsheet for the wall and the top/bottom surfaces is in the range of 2-1,000 μm, preferably 10-500 μm, and even more preferably 50-200 μm. In embodiments, the mini chamber layer can be stacked to a multilayer structure up to 10 layers.

In embodiments, the plastic chamber insulator structure further comprises at least one of the plastic face sheets having attached mechanically reinforcing and supporting pillars in an array. In embodiments, the dimension of the pillars being is in the range of 0.1-5 mm diameter, preferably 0.2-2 mm diameter, and more preferably 0.5-2 mm. In embodiments, the density of the pillars comprises at least 4 pillars, preferably at least 16 pillars, and more preferably at least 100 pillars per unit area of 100×100 cm. In certain embodiments, the spacer pillar cross-sectional geometry is selected from circular, oval, square, and rectangular geometry, or other geometries.

In embodiments, the plastic chamber insulator is attached onto a glass window with a flexible attachment mechanism, selected from, for example, velcro type, zipper type, and press-on button type attachments so as to accommodate thermal stresses and distortions.

In embodiments, the plastic chamber insulator is attached onto a glass window with the chamber insulator attachment on raised edges of the insulator or raised edges on the glass window, whereby air bubble formation is prevented, and wherein an extra insulating air gap is created for enhanced thermal insulation.

In embodiments, the plastic chamber insulator is attached onto a glass window with an added stress accommodating flexible feature between the insulating chamber and the adhesion point with the glass window surface, with the mechanically compliant and flexible insert segment selected from corrugated plastic or spring structured plastic.

In embodiments, at least one of the two face wall plastic sheets are curvatured or corrugated to accommodate thermally-induced or thermal-gradient-induced volume expansion or contraction of the gas-filled chamber.

In embodiments, the plastic chamber insulator comprises at least one vacuum or CO₂ gas fill/refill port.

In embodiments, the plastic chamber insulator comprises a volume compensator balloon-like structure that can shrink or expand to accommodate the temperature change induced gas expansion or contraction within the chamber. In embodiments, the volume compensator is selected from a plastic material with the thickness and the geometry to allow more rapid response than the plastic chamber walls. In embodiments, the configuration of a polymer balloon-like structure comprises a temperature responsive, dimension-changeable insert of negative shape memory polymer or alloy that flattens as the temperature increase to deflate the balloon so that it curves up to inflate it as the temperature decreases.

In embodiments, the plastic chamber insulator comprises a pre-made grid inserted between the top and bottom plastic panels for mechanical support.

In embodiments, the plastic chamber insulator comprises a repeatably deformable portion of the plastic chamber insulator wall structure to compensate the chamber volume shrinkage or expansion on temperature change, with the repeatably deformable portion made of thinner plastic material that responds to the change in pressure to alter its shape to accommodate the chamber volume change with a minimal change of the chamber front geometry.

In embodiments, the plastic chamber insulator comprises a half-shell plastic chamber structure attached onto the existing window glass surface using an adhesive bonding to form a plastic chamber insulator, with the attachment done by adhesive bonding to the glass, with the half-shell plastic chamber structure contains at least one flexible connect selected from corrugated or springy mechanical plastic components that can accommodate thermal expansion related distortions and stresses.

In embodiments, at least 50% of the inside volume of the vacuum-filled, air-filled or CO₂-filled chamber is filled with nanobubble polymer structure, having a nanobubble dimension of at less than 100 nm, preferably less than 50 nm, even more preferably less than 30 nm, with a thermal conductivity of less than 0.05 W/mK, and with a mechanical strength of the polymer chamber insulator increased by a factor of at least 50%, preferably 100%, even more preferably 200%.

In embodiments, a highly thermally insulating, plastic chamber insulator layer array is attached onto the glass window,-with the plastic chamber insulator layer additionally have a low-emission coating to reflect away room temperature thermal energy, with optional wear resistant coating with H hardness level of at least 5, and having a cleanability with window cleaning spray chemicals.

In embodiments, the highly thermally insulating, plastic chamber insulator layer array is completely replacing the traditional glass window as a see-through insulating layer.

In another aspect of the present disclosure, a method of preparing the plastic chamber insulator is provided. The method includes using two part plastic components and attaching them using heat bonding, chemical bonding, or adhesive bonding. Heat bonding is selected from a torch heating, convection heating, laser beam heating, radiation heating, hot air blower heating, IR heating, hot gun heating, and concentrated solar beam heating.

In another aspect of the present disclosure, a method of preparing the plastic chamber insulator is provided by using an injection molding method for either a part of the chamber or the whole chamber.

In another aspect of the present disclosure, a thermally insulating article is provided which comprises vertically elongated book-page configuration microscale chamber insulator with thermal conductivity of less than 0.10 watt/m.K, preferably less than 0.05 watt/m.K, even more preferably less than 0.03 watt/m.K. In embodiments, the configuration has at least two horizontally parallel micro plastic sheets with the edges sealed and filled with vacuum, air or CO₂ gas. In embodiments, the weight of the plastic chamber insulator is reduced by at least 40%, preferably by at least 70%, even more preferably by at least 90% as compared to the weight of the typical glass windows of identical volume, with the nano-scale vertical wall array with a thickness of the wall in the range of 50 nm-50 um, preferably in the range of 100 nm-5 um, even more preferably in the range of 100 nm-2 μm. In embodiments, the desired spacing between adjacent vertical sheet wall is at least 2 times thicker than the sheet thickness, preferably at least 5 time, even more preferably at least 10 times. In embodiments, the desired range of the height of the vertical wall in the range of 10-20,000 times the thickness of the vertical wall, preferably in the range of 100-5,000 times, more preferably in the range of 200-1,000 times.

In embodiments, the vertically elongated book-page configuration microscale chamber insulator detailed herein is comprised of a plastic material selected from polymethylmethacrylate (PMMA), polyethylene terephthalate (PET), Polyethylene naphthalate (PEN), Polybutylene terephthalate (PBT), Polyamide (PA), Polyimide (PI), polystyrene (PS), polypropylene (PP), polyester (PES), polyethylene (PR), polytetrafluoroethylene (PTFE), polydimethylsiloxane (PDMS), polyvinylidene fluoride (PVDF), polycaprolactam (nylon), polycarbonate (PC), polyoxymethylene (POM, also known as acetal), polyether ether ketone (PEEK), and co-polymers thereof and any combinations thereof, and any combination of these polymers with reinforcing inclusions such as particles or fibers of non-polymer materials.

In embodiments, the vertically elongated book-page configuration microscale chamber insulator detailed herein is such that the structure is mechanically flexible and bendable without breaking at a radius of curvature of at least 200 cm, preferably at least 100 cm, even more preferably at least 50 cm.

In embodiments, the vertically elongated book-page configuration microscale chamber insulator detailed herein comprises vertical walls that are horizontally bridged. Optionally, the vertical walls are buckled and laterally connected. In embodiments, the vertical walls are laterally wrinkled. The insulators described herein can be used for myriad applications including, but not limited to use for transparent or non-transparent insulator settings, and further including use in connection with windows, refrigerators, automobile windows, storage and shipping of food and other spoilable goods.

In another aspect of the present disclosure, a plastic chamber insulator is provided. The insulator includes at least two horizontally parallel plastic sheets, wherein edges of the plastic sheets are sealed to form a chamber having an interior, and wherein the interior of the chamber is filled with CO₂ gas, air, or vacuum. In embodiments, the plastic sheets have a thickness of less than 200 μm, and the chamber has a thickness of less than 5 mm. In certain embodiments, the ration of plastic material volume to chamber space volume is at least 10. In certain embodiments, the chamber comprises a convection-reducing structure of multilayer configuration with each layer being less than 5 mm thick, and with the number of stacked layers being less than 10. In embodiments, the chamber is compartmented into a smaller array of chambers. In certain embodiments, the dimension of the mini chambers that comprise the smaller array of chambers is less than 20×20 cm or an equivalent area, and preferably less than 5×5 cm or an equivalent area. In certain embodiments, the chamber height is less than 5 cm. In certain embodiments, the chamber insulator is sectionable and retrofittable to sizes of less than 50×50 cm or an equivalent area so as to retrofittably fit to a smaller window frame size. In embodiments, the plastic chamber insulator is optically transparent or optically non-transparent. In embodiments, the plastic chamber insulator exhibit an optical scattering haze of less than about 10%, or less than about 5%, or less than about 2%. In embodiments, the plastic chamber insulator has an optical transmission in the visible range of at least about 80%, or at least about 85%, or at least about 90%. In embodiments, the chamber further comprises an array of internal spacer pillars attached to at least one of the plastic sheets to support the plastic sheets of the chamber. In embodiments, each of the internal spacer pillars has a cross-sectional diameter of less than 5 mm. In certain embodiments, the density of pillars is at least 4 pillars per unit area of 100×100 cm. In certain embodiments the chamber insulator contains an internal support structure that comprises a grid structure positioned between the two plastic sheets. In embodiments, the plastic chamber insulator is comprised of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), or polyvinylidene fluoride (PVDF), polycaprolactam (nylon), polycarbonate (PC), polyoxymethylene (POM), polyether ether ketone (PEEK), or any combination thereof. In embodiments, the plastic chamber insulator has a thermal conductivity value of less than about 0.10 W/mK, or less than about 0.05 W/mK, or less than about 0.03 W/mK. In embodiments, at least one portion of the plastic chamber insulator contains an adhesive layer. In embodiments, the plastic chamber insulator is mechanically flexible allowing for a bending of the plastic chamber insulator having a radius of curvature of less than 2 meters. In certain embodiments, the plastic chamber insulator include a flexible and springy attachment structure or corrugated plastic extension onto the glass window to accommodate thermal and mechanical strains. In embodiments, the plastic chamber insulator further comprises raised edges. The raised edges are used for positioning against a glass window so that air bubble trapping and thermal distortion is minimized at the interface between the plastic chamber insulator and the window glass. In certain embodiments, the plastic chamber insulator comprises volume compensator which contracts or expands as the temperature is raised or lowered to counter the volume expansion or contraction of the insulator chamber space on temperature change. In certain embodiments, the volume compensator is selected from i) one or more of repeatably expanding/contracting deformable section of the plastic chamber insulator that is positioned away from the flat plastic face, ii) an inserted balloon type structure that expands or contracts as the temperature is cooed or raised, or iii) a gas fill/refill port to control the chamber gas amount and pressure with optional feedback structure. In certain embodiments, the plastic chamber insulator comprises a half-shell of the plastic chamber insulator as the front face and the existing glass window as the back face with sealed space between the two layers, and the chamber filled with air, CO2 gas or vacuum. In certain embodiments, the half-shell plastic front face comprises corrugated portion of the plastic material to accommodate the chamber mechanical shape distortion caused by temperature changes and associated thermal expansion and contraction.

In another aspect of the present disclosure, a method of producing a plastic chamber insulator is provided. The method includes positioning two or more sheets of thin and flexible plastic in a parallel configuration, wherein each of the sheets has a thickness of less than 500 μm; sealing the edges of the plastic sheets to form a chamber, wherein the chamber has an internal volume; and filling the internal the internal volume of the chamber with CO₂ gas, air or vacuum. In further embodiments, related methods include attaching the plastic chamber insulator onto a window or window frame. In embodiments, the plastic is comprised of polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), or polyvinylidene fluoride (PVDF), polycaprolactam (nylon), polycarbonate (PC), polyoxymethylene (POM), polyether ether ketone (PEEK), or any combination thereof. In further embodiments, the methods include forming a plastic chamber insulator on the window wherein the insulator is formed by: preparing the plastic chamber by injection molding, with the flexible plastic walls having a thickness less than 500 μm in parallel configuration, removing the formed plastic chamber and filling with air, CO₂ or vacuum and sealing the chamber, and attaching the chamber onto the glass window for thermal insulation. In further embodiments, the methods include forming a plastic chamber insulator on the window wherein the insulator is formed by: preparing a half-shell of the plastic chamber insulator as the front face by thermoplastic or injection shaping, attaching the half-shell plastic onto the existing glass window using adhesive seals to form a chamber filled with air, CO₂ gas or vacuum, and utilizing optionally incorporated volume-compensating structure selected from flexible, corrugated plastic wall, repeatably deformable portion, internally insertable volume compensator, or gas refill/release valve. In further embodiments, the method include forming a plastic chamber insulator on the window wherein the insulator is formed with the chamber space between the front and the rear faces secured by introducing internal spacer structure selected from one of the following methods: the internal spacer structure is provided by attaching one or more of the plastic spacer pillars onto at least one of the plastic sheets; and the internal spacer structure is provided by attaching one or more pre-made grid spacers between the two plastic sheets and position fixing them by using heat, adhesives, chemicals or mechanical means. In further embodiments, the methods include forming a plastic chamber insulator on the window wherein the insulator is formed by additionally providing a volume compensator structure shaped on one or more of the plastic sheets by heat-induced thermoplastic shaping or injection molding, and attached to the front or rear plastic sheet. In further embodiments, the volume compensator structure is selected from repeatably deformable plastic wall, internally inserted volume-changeable structure, or gas refill/release valve, and attached onto the plastic sheets or their joints. In further embodiments the methods include forming a plastic chamber insulator on the window wherein the insulator comprises a convection-reducing structure of multilayer configuration with each layer being less than 5 mm thick, with the number of stacked layers less than 10, which is formed by bonding multilayer chambers using heating, chemical bonding, or adhesive bonding, and attaching the multilayer insulator onto the glass window using adhesive or chemical bonding or mechanical attachment. In further embodiments, the methods include forming a plastic chamber insulator on the window wherein the insulator chamber is compartmented into a smaller chamber array with the mini chambers dimension being less than 20×20 cm equivalent area, and preferably less than 5×5 cm equivalent area, with the chamber height less than 5 cm. In further embodiments the plastic chamber insulator material comprises polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PR), polytetrafluoroethylene (PTFE), polydimethylsiloxane (PDMS), or polyvinylidene fluoride (PVDF), polycaprolactam (nylon), polycarbonate (PC), polyoxymethylene (POM, also known as acetal), polyether Ether Ketone (PEEK), or a combination thereof, or any combination of these polymers with reinforcing inclusions such as particles or fibers of non-polymer materials.

It is to be understood that the above-described embodiments are illustrative of only a few of the many possible specific embodiments which can represent applications of the invention. Numerous and various other arrangements can be made without departing from the spirit and scope of the invention.

We claim:

1. A thermal insulator structure comprising:
at least two parallel spaced apart sheets of plastic, wherein the at least two parallel spaced apart sheets of plastic have outer edges that are bonded to each other-to define at least one sealed chamber, wherein each chamber has an interior, and wherein each interior comprises a vacuum, air, or a gas, and wherein the structure has a thermal conductivity value of less than about 0.10 W/mK.

2. The thermal insulator structure of claim 1 further comprising a plastic component that frames the chamber, and maintains parallel spacing of the at least two parallel spaced apart sheets of plastic.

3. The thermal insulator structure of claim 1, wherein the structure has a thermal conductivity value of less than about 0.05 W/mK.

4. The thermal insulator structure of claim 1, wherein the structure has an optical transparency of at least 80% in the visible spectrum and an optical scattering haze of less than about 5%.

5. The thermal insulator structure of claim 1, wherein the gas is selected from one or more of CO₂, argon gas, or air.

6. The thermal insulator structure of claim 1, wherein the at least two parallel spaced apart sheets of plastic each have a thickness of from about 50 μm to about 200 μm.

7. The thermal insulator structure of claim 1, wherein spacing between the at least two parallel spaced apart sheets of plastic is about 0.5 mm to about 50 mm.

8. The thermal insulator structure of claim 1, further comprising internal spacer pillars, wherein each internal pillar extends between and connected to at least one of the two parallel spaced apart sheets of plastic to provide mechanical support to the at least two parallel spaced apart sheets of plastic.

9. The thermal insulator structure of claim 8, wherein each internal pillar comprises a cross-sectional area of less than about 5 mm.

10. The thermal insulator structure of claim 1, wherein the sheets of plastic comprise polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PE), polytetrafluoroethylene (PTFE), polydimethylsiloxane (PDMS), polyvinylidene fluoride (PVDF), polycaprolactam (nylon), polycarbonate (PC), polyoxymethylene (POM), or polyether ether ketone (PEEK), or co-polymers thereof, or mixtures thereof, or any combination of these polymers with reinforcing inclusions such as particles or fibers of non-polymer materials.

11. The thermal insulator structure of claim 1, wherein the structure further comprises a flexible plastic connector that can extend between the structure and a window.

12. The thermal insulator structure of claim 1, wherein the structure further comprises raised edge spacers extending from the structure to engage a window.

13. The thermal insulator structure of claim 1, wherein the structure further comprises at least one volume compensator.

14. The thermal insulator structure of claim 13, wherein the at least one volume compensator can shrink or expand in response to a temperature change within the thermal insulator structure.

15. The thermal insulator structure of claim 13, wherein the at least one volume compensator comprises a balloon-like structure.

16. The thermal insulator structure of claim 13, wherein the volume compensator comprises one or more refill-release port.

17. The thermal insulator structure of claim 1, wherein one of the parallel spaced apart sheets of plastic is replaced with a glass window surface.

18. The thermal insulator structure of claim 17, wherein the structure further comprises a flexible plastic connector that can extend between the structure and the glass window surface.

19. The thermal insulator structure of claim 1, further comprising a fastener for attaching the structure to a window.

20. The thermal insulator structure of claim 1, further comprising a low-emission coating on at least one of the spaced apart sheets of plastic.

21. The thermal insulator structure of claim 1, further comprising a wear resistant coating with a hardness level H of at least 5, the wear resistant coating being applied to at least one of the spaced apart sheets of plastic.

22. A method of forming a thermal insulator structure comprising:
bonding at least two sheets of plastic together in a parallel spaced-apart configuration to define at least one sealed chamber, wherein each chamber has an interior that comprises a vacuum, air, or a gas therein, and wherein the structure has a thermal conductivity of less than 0.10 w/mK.

23. The method of claim 22, wherein the bonding is carried out by heat, laser, chemicals or adhesives.

24. The method of claim 22, further comprising securing a plastic component to the at least two sheets of plastic to maintain spaced-apart parallel spacing of the at least two sheets of plastic.

25. The method of claim 22, further comprising connecting internal spacer pillars to at least one of the two parallel spaced apart sheets of plastic to provide mechanical support to the at least two parallel spaced apart sheets of plastic.

26. The method of claim 22, wherein one of the sheets of plastic is replaced with a glass window surface.

27. The method of claim 22, wherein the sheets of plastic comprise polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PE), polytetrafluoroethylene (PTFE), polydimethylsiloxane (PDMS), polyvinylidene fluoride (PVDF), polycaprolactam (nylon), polycarbonate (PC), polyoxymethylene (POM), or polyether ether ketone (PEEK), or co-polymers thereof, or mixtures thereof, or any combination of these polymers with reinforcing inclusions such as particles or fibers of non-polymer materials.

28. A method of forming a thermal insulator structure comprising:
(a) preparing a plastic chamber precursor by injection molding, wherein the plastic chamber precursor comprises at least, two parallel spaced apart sheets of plastic;
(b) curing the plastic chamber precursor to produce a formed plastic chamber;
(c) removing the formed plastic chamber and filling the formed plastic chamber with air, CO₂ gas, argon gas, or vacuum; and
(d) sealing the formed plastic chamber.

29. The method of claim 28, wherein the sealing is carried out by heat, laser, chemicals or adhesives.

30. The method of claim 28, wherein the plastic chamber precursor comprises polymethylmethacrylate (PMMA), polyethylene terephthalate (PET), polyethylene naphthalate (PEN), polybutylene terephthalate (PBT), polyamide (PA), polyimide (PI), polystyrene (PS), polypropylene (PP), polyester (PES), polyethylene (PE), polytetrafluoroethylene (PTFE), polydimethylsiloxane (PDMS), polyvinylidene fluoride (PVDF), polycaprolactam (nylon), polycarbonate (PC), polyoxymethylene (POM), or polyether ether ketone (PEEK), or co-polymers thereof, or mixtures thereof, or any combination of these polymers with reinforcing inclusions such as particles or fibers of non-polymer materials.
